(19) United States
(12) Patent Application Publication
(10) Pub. No.: US 2008/0113994 A1
(43) Pub. Date: May 15, 2008

(54) Annelated Quinoline Derivatives As Pesticide

(76) Inventors: Robert Velten, Langenfeld (DE); Isabelle Adelt, Dusseldorf (DE); Jutta Bohmer, Bracknell (GB); Jens Frackenpohl, Frankfurt (DE); Thomas Schenke, Bergisch Gladbach (DE); Peter Losel, Leverkusen (DE); Olga Malsam, Rosrath (DE); Christian Arnold, Langenfeld (DE)

Correspondence Address: BAYER CROPSCIENCE LP, Patent Department, 2 T .W. ALEXANDER DRIVE, RESEARCH TRIANGLE PARK, NC, 27709, US

(21) Appl. No.: 11/547,529

(22) PCT Filed: Apr. 2, 2005
(86) PCT No.: PCT/EP05/03470

§ 371 Date: Nov. 13, 2007

(30) Foreign Application Priority Data
Apr. 8, 2004 (DE) 10 2004 017 435.0

(51) Int. Cl. A01N 43/90; A01N 43/42; A01P 7/00

(52) U.S. Cl. 514/252.04; 514/291; 514/290; 514/292; 514/274

(57) ABSTRACT

The present filing of an invention relates to the use of quinoline derivatives of the formula

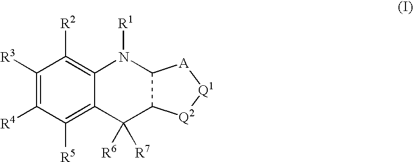

in which the dashed bond is a single or double bond and the substituents have the definition given in the disclosure,
   as crop treatment compositions, particularly for controlling animal pests; to crop treatment compositions based on known and new annulated quinoline derivatives; and to new quinoline derivatives.

The present filing of an invention relates to new annulated quinoline derivatives, to the use of known and new annulated quinoline derivatives as crop treatment compositions, particularly for controlling animal pests, and to crop treatment compositions based on known and new annulated quinoline derivatives.

A fairly large number of annulated quinoline derivatives are already known from the literature (cf. Bioorg. & Med. Chem. Lett. 10 (2000), 315-317; Chemistry Express 8 (1993), 389-392; J. Combinatorial Chem. 4 (2002), 516-522; Organic Letters 4 (2002), 3187-3189; Synlett 1996, 669-671; Tetrahedron Lett. 40 (1999), 9107-9110; EP-1103554, U.S. Pat. No. 3,910,917, WO-2002/094835, WO-2002/094840).

For the compounds indicated in the specified patent publications and in some of the stated scientific journals, however, only a possible use as drugs in the pharmaceutical sphere has been reported. The compounds indicated in the other journals cited are described only as products of studies of scientific chemistry, without any reference to a technical use.

It has now been found that the annulated quinoline derivatives of the formula (I),

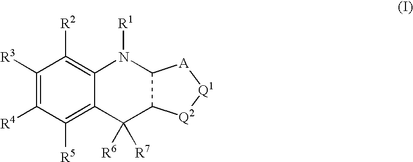

some of which are known, where in the formula (I)
the bond depicted with dashes is a single bond or a double bond
A is C═O, C═S, C═NR¹ or is optionally substituted alkanediyl (alkylene),
Q¹ is a single bond or is O (oxygen), S (sulfur), NR¹, CO, CS, CNR¹ or optionally substituted alkanediyl,
Q² is O, S, SO, SO₂, C═O, C═S, C═NR¹, NR¹, CONR¹ or optionally substituted alkanediyl,
R¹ is H (hydrogen), hydroxyl or in each case optionally substituted alkyl, alkylcarbonyl, alkoxy, alkoxycarbonyl, alkylthio, alkylsulfinyl, alkylsulfonyl alkenyl alkenyloxy alkynyl, alkynyloxy, cycloalkyl, cycloalkylcarbonyl, cycloalkylalkyl; aryl, arylcarbonyl, aryloxy, arylthio, arylsulfinyl, arylsulfonyl, arylalkyl, arylalkylcarbonyl, arylalkoxy, arylalkylthio, arylalkylsulfinyl, arylakylsulfonyl, heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl or heterocyclylalkylsulfonyl,
R² is H (hydrogen), hydroxyl, amino, nitro, cyano, carboxyl, carbamoyl, thiocarbamoyl, halogen, or is in each case optionally substituted alkyl, alkoxy, alkylthio, alkylsulfinyl, alkylsulfonyl, alkylamino, dialkylamino, dialkylaminocarbonyl or dialkylaminosulfonyl,
R³ is H, hydroxyl, amino, nitro, cyano, carboxyl, carbamoyl, thiocarbamoyl, halogen, or is in each case optionally substituted alkyl, alkoxy, alkylthio, alkylsulfinyl, alkylsulfonyl, alkylamino, dialkylamino, dialkylaminocarbonyl or dialkylaminosulfonyl, or
   together with R² is a benzo moiety or alkanediyl, oxaalkanediyl or dioxaalkanediyl,
R⁴ is H, hydroxyl, amino, nitro, cyano, carboxyl, carbamoyl, thiocarbamoyl, halogen, or is in each case optionally substituted alkyl, alkoxy, alkylthio, alkylsulfinyl, alkylsulfonyl, alkylamino, dialkylamino, dialkylaminocarbonyl or dialkylaminosulfonyl, or
   together with R³ is a benzo moiety or alkanediyl, oxaalkanediyl or dioxaalkanediyl,
R⁵ is H (hydrogen), hydroxyl, amino, nitro, cyano, carboxyl, carbamoyl, thiocarbamoyl, halogen, or is in each case optionally substituted alkyl, alkoxy, alkylthio, alkylsulfinyl, alkylsulfonyl, alkylamino, dialkylamino, dialkylaminocarbonyl or dialkylaminosulfonyl,
   or together with R⁴ is a benzo moiety or alkanediyl, oxaalkanediyl or dioxaalkanediyl,
R⁶ is H or optionally substituted alkyl, and
R⁷ is H or is in each case optionally substituted alkyl, cycloalkyl, cycloalkylalkyl, aryl, arylalkyl, heterocyclyl or heterocyclylalkyl,
   and also salts or adducts formed from the compounds of the formula (I) with acids or bases,
   exhibit strong activity with respect to animal pests.

Saturated or unsaturated hydrocarbon radicals such as alkyl or alkenyl, both alone and in conjunction with heteroatoms, as in alkoxy, may—where possible—in each case be linear or branched.

Optionally substituted radicals may be substituted one or more times, and in the case of multiple substitution the substituents may be identical or different.

Halogen-substituted radicals, such as haloalkyl, may contain one or more halogen substituents. In the case of multiple substitution by halogen these substituents may be identical or different. Halogen in this context is fluorine, chlorine, bromine or iodine, particularly fluorine, chlorine or bromine.

Inventive compounds of the general formula (I) which contain at least one asymmetrically substituted carbon atom can be present in different enantiomeric forms (R- and S-configured forms) and/or diastereomeric forms. The invention relates not only to the use of the various possible individual enantiomeric and/or stereoisomeric forms of the compounds of the general formula (I) but also of the mixtures of these isomeric compounds.

Preferred substituents and ranges of the radicals present in the formulae given above and below are described in the following text.
A preferably is C═O, C═S, C═NR¹ or is C₁-C₆-alkanediyl which is optionally substituted by hydroxyl, cyano, halogen, C₁-C₄-alkoxy or C₁-C₄-haloalkoxy and is optionally branched, i.e. optionally substituted by C₁-C₄-alkyl, and/or spirocyclically linked with C₂-C₆-alkanediyl.
A with particular preference is C═O, C═S, C═NR¹ or is in each case optionally hydroxyl-, cyano-, fluoro-, chloro-, bromo-, methoxy-, ethoxy-, n- or isopropoxy-, monofluoromethoxy-, difluoromethoxy-, trifluoromethoxy-, monofluoroethoxy-, difluoroethoxy- or trifluoroethoxy-substituted methylene, ethane-1,1-diyl, ethane-1,2-diyl (dimethylene), propane-1,1-diyl, propane-1,2-diyl, 2-methylpropane-1,2-diyl, propane-2,2-diyl, propane-1,3-diyl (trimethylene) or 4-methylpentane-2,2-diyl, where A=methylene can also be spirocyclically linked to dimethylene, trimethylene, tetramethylene or pentamethylene.
A with very particular preference is in each case optionally hydroxyl-, fluoro-, chloro-, methoxy- or ethoxy-substituted methylene, ethane-1,1-diyl, ethane-1,2-diyl (dimethylene), propane-1,1-diyl, propane-1,2-diyl, 2-methylpropane-1,2-diyl or propane-2,2-diyl.
Q¹ preferably is a single bond, or is O (oxygen), S (sulfur), N—R¹, or is C═O, C═S, C═NR¹ or is C₁-C₆-alkanediyl which is optionally substituted by hydroxyl, cyano, halogen, C₁-C₄-alkoxy or C₁-C₄-haloalkoxy and is optionally branched, i.e. optionally substituted by C₁-C₄-alkyl, and/or spirocyclically linked with C₂-C₆-alkanediyl.
Q¹ with particular preference is a single bond, is or is O (oxygen), S (sulfur) or N—R¹, or is C═O, C═S, C═NR¹ or is in each case optionally hydroxyl-, cyano-, fluoro-, chloro-, bromo-, methoxy-, ethoxy-, n- or isopropoxy-, monofluoromethoxy-, difluoromethoxy-, trifluoromethoxy-, monofluoroethoxy-, difluoroethoxy- or trifluoroethoxy-substituted methylene, ethane-1,1-diyl, ethane-1,2-diyl (dimethylene), propane-1,1-diyl, propane-1,2-diyl, 2-methylpropane-1,2-diyl, propane-2,2-diyl, propane-1,3-diyl (trimethylene) or 4-methylpentane-2,2-diyl, where A=methylene can also be spirocyclically linked with dimethylene, trimethylene, tetramethylene or pentamethylene.
Q¹ with very particular preference is a single bond, is O (oxygen) or N—R¹ or hydroxyl-, fluoro-, chloro-, methoxy- or ethoxy-substituted methylene, ethane-1,1-diyl, ethane-1,2-diyl (dimethylene), propane-1,1-diyl, propane-1,2-diyl, 2-methylpropane-1,2-diyl or propane-2,2-diyl.
Q² preferably is O (oxygen), S (sulfur), SO, SO₂ or CONR¹ or is C═O, C═S, C═NR¹ or is C₁-C₆-alkanediyl which is optionally substituted by hydroxyl, cyano, halogen, C₁-C₄-alkoxy or C₁-C₄-haloalkoxy and is optionally branched, i.e. optionally substituted by C₁-C₄-alkyl, and/or spirocyclically linked with C₂-C₆-alkanediyl.
Q² with particular preference is O (oxygen), S (sulfur), SO, SO₂, CONR¹ or is C═O, C═S, C═NR¹ or is in each case optionally hydroxyl-, cyano-, fluoro-, chloro-, bromo-, methoxy-, ethoxy-, n- or isopropoxy-, monofluoromethoxy-, difluoromethoxy-, trifluoromethoxy-, monofluoroethoxy-, difluoroethoxy- or trifluoroethoxy-substituted methylene, ethane-1,1-diyl, ethane-1,2-diyl (dimethylene), propane-1,1-diyl, propane-1,2-diyl, 2-methylpropane-1,2-diyl, propane-2,2-diyl, propane-1,3-diyl (trimethylene) or 4-methylpentane-2,2-diyl, where A=methylene can also be spirocyclically linked with dimethylene, trimethylene, tetramethylene or pentamethylene.
Q² with very particular preference is O (oxygen), S (sulfur), SO, SO₂ or hydroxyl-, fluoro-, chloro-, methoxy- or ethoxy-substituted methylene, ethane-1,1-diyl, ethane-1,2-diyl (dimethylene), propane-1,1-diyl, propane-1,2-diyl, 2-methylpropane-1,2-diyl or propane-2,2-diyl but where in each individual case Q¹ and Q² are different unless they are A.
R¹ preferably is H (hydrogen), hydroxyl, in each case optionally hydroxyl-, cyano-, halogen-, C₁-C₄-alkoxy-, C₁-C₄-alkylthio-, C₁-C₄-alkylsulfinyl-, C₁-C₄-alkylsulfonyl-, C₁-C₄-alkylamino- or di(C₁-C₄-alkyl)amino-substituted alkyl, alkylcarbonyl, alkoxy, alkoxycarbonyl, alkylthio, alkylsulfinyl or alkylsulfonyl having in each case up to 6 carbon atoms in the alkyl groups, in each case optionally cyano- or halogen-substituted alkenyl, alkenyloxy, alkynyl or alkynyloxy having in each case up to 6 carbon atoms, in each case optionally cyano-, halogen- or C₁-C₄-alkyl-substituted cycloalkyl, cycloalkylcarbonyl or cycloalkylalkyl having in each case up to 6 carbon atoms in the cycloalkyl group and optionally up to 4 carbon atoms in the alkyl moiety, in each case optionally nitro-, hydroxyl-, amino-, cyano-, carbamoyl-, thiocarbamoyl-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl-, C₁-C₄-haloalkylsulfonyl-, C₁-C₄-alkylamino-, di(C₁-C₄-alkyl)amino-, di(C₁-C₄-alkyl)aminocarbonyl; di(C₁-C₄-alkyl)aminosulfonyl-, C₁-C₃-alkylenedioxy- or C₁-C₃-haloalkylenedioxy-substituted aryl, arylcarbonyl, aryloxy, arylthio, arylsulfinyl, arylsulfonyl, arylalkyl, arylalkylcarbonyl, arylalkoxy, arylalkylthio, arylalkylsulfinyl or arylalkylsulfonyl having in each case 6 or 10 carbon atoms in the aryl group and optionally up to 4 carbon atoms in the alkyl moiety, or in each case optionally nitro-, hydroxyl-, amino-, cyano-, carbamoyl-, thiocarbamoyl-, halogen-, C₁-C₆-alkyl-, C₁-C₄-thioalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄alkylsulfonyl-, C₁-C₄-haloalkylsulfonyl-, C₁-C₄-alkylamino-, di(C₁-C₄-alkyl)amino-, di(C₁-C₄-alkyl)aminocarbonyl-, di(C₁-C₄-alkyl)aminosulfonyl-, C₁-C₃-alkylenedioxy- or C₁-C₃-haloalkylenedioxy-substituted heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl or heterocyclylalkylsulfonyl, the heterocyclyl moiety being saturated or unsaturated, monocyclic or bicyclic and containing in each case up to 10 carbon atoms, 1 to 4 N atoms and/or one O atom and/or one S atom.
R¹ with particular preference is H (hydrogen), hydroxyl, in each case optionally hydroxyl-, cyano-, fluoro-, chloro-, bromo-, methoxy-, ethoxy-, n- or isopropoxy-, methylthio-, ethylthio-, n- or isopropylthio-, methylsulfinyl-, ethylsulfinyl-, methylsulfonyl-, ethylsulfonyl-, methylamino-, ethylamino-, n- or isopropylamino-, dimethylamino- or diethylamino-substituted methyl, ethyl, n- or isopropyl, n-, iso-, s- or t-butyl, acetyl, propionyl, n- or isobutyryl, methoxy, ethoxy, n- or isopropoxy, n-, iso-, s- or t-butoxy, methoxycarbonyl, ethoxycarbonyl, n- or isopropoxycarbonyl, n-, iso-, s- or t-butoxycarbonyl, methylthio, ethylthio, n- or isopropylthio, n-, iso-, s- or t-butylthio, methylsulfinyl, ethylsulfinyl, n- or isopropylsulfinyl, methylsulfonyl or ethylsulfonyl, in each case optionally cyano-, fluoro-, chloro- or bromo-substituted ethenyl, propenyl, butenyl, pentenyl, propenyloxy, butenyloxy, pentenyloxy, ethynyl, propynyl, butynyl, pentynyl, propynyloxy, butynyloxy or pentynyloxy, in each case optionally cyano-, fluoro-, chloro-, bromo-, methyl-, ethyl-, n- or isopropyl-substituted cyclopropyl, cyclobutyl, cyclopentyl, cyclohexyl, cyclopropylcarbonyl, cyclobutylcarbonyl, cyclopentylcarbonyl, cyclohexylcarbonyl, cyclopropyloxy, cyclobutyloxy, cyclopentyloxy or cyclohexyloxy, in each case optionally nitro-, hydroxyl-, amino-, cyano-, carbamoyl-, thiocarbamoyl-, fluoro-, chloro-, bromo-, iodo-, methyl-, ethyl-, n- or isopropyl-, n-, iso-, s- or t-butyl-, difluoromethyl-, trifluoromethyl-, dichloromethyl-, trichloromethyl-, chlorodifluoromethyl, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s- or t-butoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s- or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy- or chlorodifluorodimethylenedioxy-substituted phenyl, naphthyl, phenylcarbonyl (benzoyl), naphthylcarbonyl, phenoxy, naphthyloxy, phenylthio, naphthylthio, phenylsulfinyl, phenylsulfonyl, benzyl, phenylethyl, phenylpropyl, phenylacetyl, phenylpropionyl, phenylmethoxy, phenylethoxy, phenylpropoxy, phenylmethylthio, phenylethylthio, phenylmethylsulfnyl or phenylmethylsulfonyl, or in each case optionally nitro-, hydroxyl-, amino-, cyano-, carbamoyl-, thiocarbamoyl-, fluoro-, chloro-, bromo-, iodo-, methyl-, ethyl-, n- or isopropyl-, n-, iso-, s- or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s- or t-butoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s- or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy- or chlorodifluorodimethylenedioxy-substituted heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl or heterocyclylalkylsulfonyl, the heterocyclyl moiety being selected from the series consisting of furyl, tetrahydrofuryl, thienyl, pyrrolyl, pyrrolinyl, pyrrolidinyl, pyrazolyl, pyrazolinyl, imidazolyl, imidazolinyl, oxazolyl, oxazolinyl, isoxazolyl, isoxazolinyl, thiazolyl, oxadiazolyl, thiadiazolyl, triazolyl, triazolinyl, pyridinyl, pyridazinyl, pyrimidinyl, and pyrazinyl.
R¹ with very particular preference is H (hydrogen), hydroxy, in each case optionally hydroxyl-, cyano-, fluoro-, chloro-, methoxy-, ethoxy-, n- or isopropoxy-substituted methyl, ethyl, n- or isopropyl, acetyl, propionyl, n- or isobutyryl, methoxy, ethoxy, n- or isopropoxy, methoxycarbonyl, ethoxycarbonyl, n- or isopropoxycarbonyl, methylthio, ethylthio, n- or isopropylthio, methylsulfinyl, ethylsulfinyl, methylsulfonyl or ethylsulfonyl, in each case optionally fluoro-, chloro- or bromo-substituted propenyl, butenyl, propenyloxy, butenyloxy, propynyl or butynyl, in each case optionally fluoro-, chloro- or methyl-substituted cyclopropyl, cyclopentyl, cyclohexyl, cyclopropylcarbonyl, cyclopentylcarbonyl, cyclohexylcarbonyl, cyclopropylmethyl, cyclopentylmethyl or cyclohexylmethyl, in each case optionally nitro-, hydroxyl-, cyano-, carbamoyl-, thiocarbamoyl-, fluoro-, chloro-, bromo-, methyl-, ethyl-, n- or isopropyl-, n-, iso-, s- or t-butyl, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy- or chlorodifluorodimethylenedioxy-substituted phenyl, phenylcarbonyl (benzoyl), phenoxy, phenylthio, phenylsulfinyl, phenylsulfonyl, benzyl, phenylethyl, phenylacetyl; phenylmethoxy, phenylethoxy, phenylmethylthio, phenylmethylsulfinyl or phenylmethylsulfonyl.
R² preferably is H (hydrogen), hydroxyl, amino, nitro, cyano, carboxyl, carbamoyl, thiocarbamoyl, halogen, or is in each case optionally hydroxyl-, cyano-, halogen-, C₁-C₄-alkoxy-, C₁-C₄-alkylamino- or di(C₁-C₄-alkyl)amino-substituted alkyl, alkoxy, alkylthio, alkylsulfinyl, alkylsulfonyl, alkylamino, dialkylamino, dialkylaminocarbonyl or dialkylaminosulfonyl having in each case up to 6 carbon atoms in the alkyl groups.
R² with particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, n-, iso, s- or t-butyl, methoxy, ethoxy, n- or isopropoxy, n-, iso-, s- or t-butoxy, methylthio, ethylthio, n- or isopropylthio, n-, iso-, s- or t-butylthio, methylsulfinyl, ethylsulfinyl, n- or isopropylsulfinyl, methylsulfonyl, ethylsulfonyl, methylamino, ethylamino, n- or isopropylamino, n-, iso-, s- or t-butylamino, dimethylamino, diethylamino, dimethylaminocarbonyl, diethylaminocarbonyl, dimethylaminosulfonyl or diethylaminosulfonyl.
R² with very particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl or dimethylaminosulfonyl.
R³ preferably is H (hydrogen), hydroxyl, amino, nitro, cyano, carboxyl, carbamoyl, thiocarbamoyl, halogen, or is in each case optionally hydroxyl-, cyano-, halogen-, C₁-C₄-alkoxy-, C₁-C₄-alkylamino- or di(C₁-C₄-alkyl)amino-substituted substituted alkyl, alkoxy, alkylthio, alkylsulfinyl, alkylsulfonyl, alkylamino, dialkylamino, carbonyl or dialkylaminosulfonyl having in each case up to 6 carbon atoms in the alkyl groups, or
   together with R² is a benzo moiety or alkanediyl, oxaalkanediyl or dioxaalkanediyl having in each case up to 4 carbon atoms.
R³ with particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino, n- or isopropylamino-, dimethylamino- or diethylamino-substituted methyl, ethyl, n- or isopropyl, n-, iso, s- or methoxy, ethoxy, n- or isopropoxy, n-, iso-, s- or t-butoxy, methylthio, ethylthio, n- or isopropylthio, n-, iso-, s- or t-butylthio, methylsulfinyl, ethylsulfinyl, n- or isopropylsulfinyl, methylsulfonyl, ethylsulfonyl, methylamino, ethylamino, n- or isopropylamino, n-, iso-, s- or t-butylamino, dimethylamino, diethylamino, dimethylaminocarbonyl, diethylaminocarbonyl, dimethylaminosulfonyl or diethylamino sulfonyl, or
   together with R³ is a benzo moiety or is in each case optionally fluoro- and/or chloroand/or methyl-substituted propane-1,3-diyl (trimethylene), butane-1,4-diyl (tetramethylene), 1-oxapropane-1,3-diyl, 1-oxabutane-1,4-diyl, 3-oxapentane-1,5-diyl, 1,3-dioxapropane-1,3-diyl (methylenedioxy), 1,4-dioxabutane-1,4-diyl (dimethylenedioxy).
R³ with very particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl or dimethylaminosulfonyl, or
   together with R² is a benzo moiety or methylenedioxy.
R⁴ preferably is H (hydrogen), hydroxyl, amino, nitro, cyano, carboxyl, carbamoyl, thiocarbamoyl, halogen, or is in each case optionally hydroxyl-, cyano-, halogen-, C₁-C₄-alkoxy-, C₁-C₄-alkylamino- or di(C₁-C₄-alkyl)amino-substituted substituted alkyl, alkoxy, alkylthio, alkylsulfinyl, alkylsulfonyl, alkylamino, dialkylamino, dialkylaminocarbonyl or dialkylaminosulfonyl having in each case up to 6 carbon atoms in the alkyl groups, or
   together with R³ is a benzo moiety or alkanediyl, oxaalkanediyl or dioxaalkanediyl having in each case up to 4 carbon atoms.
R⁴ with particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, n-, iso, s- or t-butyl, methoxy, ethoxy, n- or isopropoxy, n-, iso-, s- or t-butoxy, methylthio, ethylthio, n- or isopropylthio, n-, iso-, s- or t-butylthio, methylsulfinyl, ethylsulfinyl, n- or isopropylsulfinyl, methoxysulfonyl, ethylsulfonyl, methylamino, ethylamino, n- or isopropylamino, n-, iso-, s- or t-butylamino, dimethylamino, diethylamino, dimethylaminocarbonyl, diethylaminocarbonyl, dimethylaminosulfonyl or diethylaminosulfonyl, or
   together with R³ is a benzo moiety or is in each case optionally fluoro- and/or chloroand/or methyl-substituted propane-1,3-diyl (trimethylene), butane-1,4-diyl (tetramethylene), 1-oxapropane-1,3-diyl, 1-oxabutane-1,4-diyl, 3-oxapentane-1,5-diyl, 1,3-dioxapropane-1,3-diyl (methylenedioxy), 1,4-dioxabutane-1,4-diyl (dimethylenedioxy).
R⁴ with very particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl or dimethylaminosulfonyl, or
   together with R³ is a benzo moiety or methylenedioxy.
R⁵ preferably is H (hydrogen), hydroxyl, amino, nitro, cyano, carboxyl, carbamoyl, thiocarbamoyl, halogen, or is in each case optionally hydroxyl-, cyano-, halogen-, C₁-C₄-alkoxy-, C₁-C₄-alkylamino- or di(C₁-C₄-alkyl)amino-substituted substituted alkyl, alkoxy, alkylthio, alkylsulfinyl, alkylsulfonyl, alkylamino, dialkylamino, dialkylaminocarbonyl or dialkylaminosulfonyl having in each case up to 6 carbon atoms in the alkyl groups, or
   together with R⁴ is a benzo moiety or alkanediyl, oxaalkanediyl or dioxaalkanediyl having in each case up to 4 carbon atoms
R⁵ with particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, n-, iso, s- or t-butyl, methoxy, ethoxy, n- or isopropoxy, n-, iso-, s- or t-butoxy, methylthio, ethylthio, n- or isopropylthio, n-, iso-, s- or t-butylthio, methylsulfinyl, ethylsulfinyl, n- or isopropylsulfinyl, methylsulfonyl, ethylsulfonyl, methylamino, ethylamino, n- or isopropylamino, n-, iso-, s- or t-butylamino, dimethylamino, diethylamino, dimethylaminocarbonyl, diethylaminocarbonyl, dimethylaminosulfonyl or diethylaminosulfonyl, or
   together with R⁴ is a benzo moiety or is in each case optionally fluoro- and/or chloroand/or methyl-substituted propane-1,3-diyl (trimethylene), butane-1,4-diyl (tetramethylene), 1-oxapropane-1,3-diyl, 1-oxabutane-1,4-diyl, 3-oxapentane-1,5-diyl, 1,3-dioxapropane-1,3-diyl (methylenedioxy), 1,4-dioxabutane-1,4-diyl (dimethylenedioxy).
R⁵ with very particular preference is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, methylamino-, ethylamino-, n- or isopropylamino-, dimethylamino- or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl or dimethylaminosulfonyl, or
   together with R⁴ is a benzo moiety or methylenedioxy.
R⁶ preferably is H (hydrogen) or is optionally hydroxyl-, cyano- or halogen-substituted alkyl having up to 6 carbon atoms.
R⁶ with particular preference is H (hydrogen) or is in each case optionally hydroxyl-, cyano- or halogen-substituted methyl, ethyl, n- or isopropyl, n-, iso-, s- or t-butyl.
R⁶ with very particular preference is H (hydrogen) or is in each case optionally hydroxyl-, cyano-, fluoro- or chloro-substituted methyl, ethyl, n- or isopropyl.
R⁷ preferably is H (hydrogen), optionally hydroxyl-, cyano-, halogen-, C₁-C₄-alkoxy-, C₁-C₄-alkylthio-, C₁-C₄-alkylsulfinyl-, C₁-C₄-alkylsulfonyl-, C₁-C₄-alkylamino- or di(C₁-C₄-alkyl)amino-substituted alkyl having up to 6 carbon atoms, in each case optionally cyano-, halogen- or C₁-C₄-alkyl-substituted cycloalkyl or cycloalkylalkyl having in each case up to 6 carbon atoms in the cycloalkyl group and optionally up to 4 carbon atoms in the alkyl moiety, in each case optionally nitro-, hydroxyl-, amino-, cyano-, carbamoyl-, thiocarbamoyl-, phenyl-, phenoxy-, benzyloxy-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl, C₁-C₄-haloalkylsulfonyl-, C₁-C₄-alkylamino-, di(C₁-C₄-alkyl)amino-, di(C₁-C₄alkyl)aminocarbonyl, di(C₁-C₄-alkyl)aminosulfonyl-, C₁-C₃-alkylenedioxy- or C₁-C₃-haloalkylenedioxy-substituted aryl or arylalkyl having in each case 6 or 10 carbon atoms in the aryl group and optionally up to 4 carbon atoms in the alkyl moiety, or in each case optionally nitro-, hydroxyl-, amino-, cyano-, carbamoyl-, thiocarbamoyl-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl-, C₁-C₄-haloalkylsulfonyl-, C₁-C₄-alkylamino-, di(C₁-C₄-alkyl)amino-, (C₁-C₄-alkyl)aminocarbonyl-, di(C₁-C₄-alkyl)aminosulfonyl-, C₁-C₃-alkylenedioxy- or C₁-C₃-haloalkylenedioxy-substituted heterocyclyl or heterocyclylalkyl, the heterocyclyl moiety being saturated or unsaturated, monocyclic or bicyclic and containing in each case up to 10 carbon atoms, 1 to 4 N atoms and/or one O atom and/or one S atom.
R⁷ with particular preference is H (hydrogen), in each case optionally hydroxyl-, cyano-, fluoro-, chloro-, bromo-, methoxy-, ethoxy-, n- or isopropoxy-, methylthio-, ethylthio-, n- or isopropylthio-, methylsulfinyl-, ethylsulfinyl-, methylsulfonyl-, ethylsulfonyl-, methylamino-, ethylamino-, n- or isopropylamino-, dimethylamino- or diethylamino-substituted methyl, ethyl, n- or isopropyl, n-, iso-, s- or t-butyl, in each case optionally cyano-, fluoro-, chloro- or methyl-substituted cyclopropyl, cyclopentyl, cyclohexyl, cyclopropylmethyl, cyclopentylmethyl or cyclohexylmethyl, in each case optionally nitro-, hydroxyl-, amino-, cyano-, carbamoyl-, thiocarbamoyl-, phenyl-, phenoxy-, fluoro-, chloro-, bromo-, iodo-, methyl-, ethyl-, n- or isopropyl-, n-, iso-, s- or t-butyl, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s- or t-butoxy, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s- or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy- or chlorodifluorodimethylenedioxy-substituted phenyl, naphthyl or benzyl, phenylethyl or phenylpropyl, or in each: case optionally nitro-, hydroxyl-, amino-, cyano-, carbamoyl-, thiocarbamoyl-, fluoro-, chloro-, bromo-, iodo-, methyl-, ethyl-, n- or isopropyl-, n-, iso-, sor t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s- or t-butoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s- or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylamino sulfonyl-, methylenedioxy-, dimethylenedioxy-, difluoromethylenedioxy-, difluorodimethylenedioxy-, trifluorodimethylenedioxy- or chlorodifluorodimethylenedioxy-substituted heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl or heterocyclylalkylsulfonyl, the heterocyclyl moiety being selected from the series consisting of furyl, tetrahydrofuryl, thienyl, pyrrolyl, pyrrolinyl, pyrrolidinyl, pyrazolyl, pyrazolinyl, imidazolyl, imidazolinyl, oxazolyl, oxazolinyl, isoxazolyl, isoxazolinyl, thiazolyl, oxadiazolyl, thiadiazolyl, triazolyl, triazolinyl, pyridinyl, pyridazinyl, pyrimidinyl, and pyrazinyl.
R⁷ with very particular preference is H (hydrogen), in each case optionally hydroxyl-, cyano-, fluoro-, chloro-, methoxy-, ethoxy-, n- or isopropoxy-substituted methyl, ethyl, n- or isopropyl, in each case optionally fluoro-, chloro- or methyl-substituted cyclopropyl, cyclopentyl, cyclohexyl, cyclopropylmethyl, cyclopentylmethyl or cyclohexylmethyl, in each case optionally nitro-, hydroxyl-, cyano-, carbamoyl-, thiocarbamoyl-, fluoro-, chloro-, bromo-, methyl-, ethyl-, n- or isopropyl-, n-, iso-, s- or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy- or chlorodifluorodimethylenedioxy-substituted phenyl, benzyl or phenylethyl, or is in each case optionally fluoro-, chloro-, bromo-, methyl- or ethyl-substituted thienyl or pyridinyl.

Inventively preferred is the inventive use of compounds of the formula (I) in which there is a combination of the definitions indicated above as being preferable.

Inventively particularly preferred is the inventive use of compounds of the formula (I) in which there is a combination of the definitions indicated above as enjoying particular preference.

Inventively very particularly preferred is the inventive use of compounds of the formula (I) in which there is a combination of the definitions indicated above as enjoying very particular preference.

An especially preferred group are those compounds of the formula (I) in which the bond depicted with dashes is a double bond and A, Q¹, Q², R¹, R², R³, R⁴, R⁵, R⁶ and R⁷ have the definitions givenbelow:
A in this case is methylene, ethane-1,1-diyl, ethane-1,2-diyl (dimethylene), propane-1,1-diyl, propane-1,2-diyl or 2-methylpropane-1,2-diyl.
Q¹ in this case is a single bond, is methylene, ethane-1,1-diyl, ethane-1,2-diyl (dimethylene), propane-1,1-diyl, propane-1,2-diyl or 2-methylpropane-1,2-diyl, or is O (oxygen) or N—R¹, R¹ being hydrogen, methyl, ethyl, n- or isopropyl, or phenyl.
Q² in this case is methylene, is O (oxygen), S (sulfur), SO, SO₂ or CO, but where in each individual case Q¹ and Q² are different unless they are methylene,
R¹ in this case is H (hydrogen), in each case optionally hydroxyl-, cyano-, fluoro-, chloro-, methoxy-, ethoxy-, n- or isopropoxy-substituted methyl, ethyl, n- or isopropyl, acetyl, propionyl, n- or isobutyryl, methoxy, ethoxy, n- or isopropoxy, methoxycarbonyl, ethoxycarbonyl, n- or isopropoxycarbonyl, methylthio, ethylthio, n- or isopropylthio, methylsulfinyl, ethylsulfinyl, methylsulfonyl or ethylsulfonyl, in each case optionally fluoro-, chloro- or bromo-substituted propenyl, butenyl, propynyl or butynyl, in each case optionally fluoro-, chloro- or methyl-substituted cyclopropyl, cyclopentyl, cyclohexyl, cyclopropylcarbonyl, cyclopentylcarbonyl, cyclohexylcarbonyl cyclopropylmethyl, cyclopentylmethyl or cyclohexylmethyl, in each case optionally nitro-, hydroxyl-, cyano-, carbamoyl-, thiocarbamoyl-, fluoro-, chloro-, bromo-, methyl-, ethyl-, n- or isopropyl-, n-, iso-, s- or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy, trifluorodimethylenedioxy or chlorodifluorodimethylenedioxy-substituted phenyl, phenylcarbonyl (benzoyl), phenylthio, phenylsulfinyl, phenylsulfonyl, benzyl, phenylethyl, phenylacetyl, phenylmethylthio, phenylmethylsulfinyl or phenylmethylsulfonyl.
R² in this case is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, dimethylamino- or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, dimethylamino, dimethylaminocarbonyl or dimethylaminosulfonyl.
R³ in this case is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, dimethylamino- or diethylamino-substituted methyl, ethyl, n- or isopropyl, methoxy, ethoxy, n- or isopropoxy, methylthio, ethylthio n- or isopropylthio, methylsulfinyl, ethylsulfinyl, methylsulfonyl, ethylsulfonyl, dimethylamino, dimethylaminocarbonyl or dimethylaminosulfonyl, or together with R² is a benzo moiety.
R⁴ in this case is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, dimethylamino- or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, dimethylamino, dimethylaminocarbonyl or dimethylaminosulfonyl, or together with R³ is a benzo moiety.
R⁵ in this case is H (hydrogen), hydroxyl, amino, nitro, cyano, carboxyl, carbamoyl, thiocarbamoyl, fluorine, chlorine, bromine, or is in each case optionally hydroxyl-, cyano-, fluoro-, chloro-, methoxy-, ethoxy-, n- or isopropoxy-, dimethylamino- or diethylamino-substituted methyl, ethyl, n- or isopropyl, methoxy, ethoxy, n- or isopropoxy; methylthio, ethylthio, n- or isopropylthio, methylsulfinyl, ethylsulfinyl, methylsulfonyl, ethylsulfonyl, dimethylamino, dimethylaminocarbonyl or dimethylaminosulfonyl, or together with R⁴ is a benzo moiety.
R⁶ in this case is H (hydrogen) or is in each case optionally hydroxyl-, cyano-, fluoro- or chloro-substituted methyl, ethyl, n- or isopropyl.
R⁷ in this case is H (hydrogen), in each case optionally hydroxyl-, cyano-, fluoro-, chloro-, methoxy-, ethoxy-, n- or isopropoxy-substituted methyl, ethyl, n- or isopropyl, in each case optionally fluoro-, chloro- or methyl-substituted: cyclopropyl, cyclopentyl, cyclohexyl, cyclopropylmethyl, cyclopentylmethyl or cyclohexylmethyl, in each case optionally nitro-, hydroxyl-, cyano-, carbamoyl-, thiocarbamoyl-, fluoro-, chloro-, bromo-, methyl-, ethyl-, n- or isopropyl-, n-, iso-, s- or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethylene-, chlorofluroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy- or chlorodifluorodimethylenedioxy-substituted phenyl, benzyl or phenylethyl, or is in each case optionally fluoro-, chloro-, bromo-, methyl- or ethyl-substituted thienyl or pyridinyl.

An additionally especially preferred group of the compounds are those compounds of the formula (I) in which

### R³ and R⁴ together are O—CH₂—O,

### R⁵ is H, and

### R⁶ is H.

An additionally especially preferred group of the compounds are those compounds of the formula (I) in which

### A is CH₂

### Q¹ is O

### Q² is CO.

An additionally especially preferred group of the compounds are those compounds of the formula (I) in which the

dashed line in the formula (I) is a double bond.

An additionally especially preferred group of the compounds are those compounds of the formula (I) in which

### R⁶ is H and

### R⁷ is substituted phenyl.

Examples of the compounds of the formula (I) for inventive use are listed in table 1 below.

TABLE 1
Examples of the compounds of the formula (I)

| | |
|---|---|
| | (I) |
| 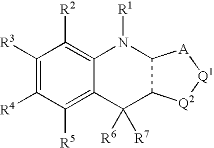 | |

In the compounds of the formula (I) listed in the table below, the dashed line corresponds to a double bond.

| Ex. | | | | | | R³ or | | | | | |
|---|---|---|---|---|---|---|---|---|---|---|---|
| No. | A | Q¹ | Q² | R¹ | R² | R³ + R⁴ | R⁴ | R⁵ | R⁶ | R⁷ | Physical data^{[a]} |
| 1 | —CH₂— | O | C═O | H | H | —O—CH₂—O— | — | H | H | 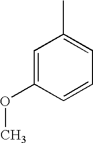 | 338 (MH⁺, 100)/4.59 min |
| 2 | —CH₂— | O | C═O | H | H | —O—CH₂—O— | — | H | H | 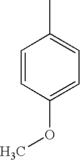 | 338 (MH⁺, 20)/4.50 min |
| 3 | —CH₂— | O | C═O | H | H | —O—CH₂—O— | — | H | H | 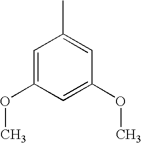 | 368 (MH⁺, 100)/4.62 min |
| 4 | —CH₂— | O | C═O | H | H | —O—CH₂—O— | — | H | H | 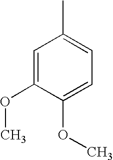 | 368 (MH⁺, 10)/4.09 min |
| 5 | —CH₂— | O | C═O | H | H | —O—CH₂—O— | — | H | H | 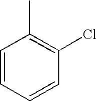 | 342 (MH⁺, 100)/4.99 min |
| 6 | —CH₂— | O | C═O | H | H | —O—CH₂—O— | — | H | H | 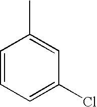 | 342 (MH⁺, 100)/5.12 min |
| 7 | —CH₂— | O | C═O | H | H | —O—CH₂—O— | — | H | H | 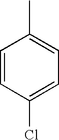 | 342 (MH⁺, 100)/5.18 min |
| 8 | —CH₂— | O | C═O | H | H | H | OCH₃ | H | H | 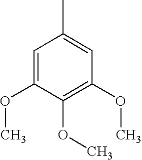 | 384 (MH⁺, 40)/4.16 min |
| 9 | —CH₂— | O | C═O | H | H | OCH₃ | H | H | H | 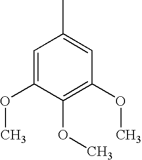 | 384 (MH⁺, 25)/4.32 min |
| 10 | —CH₂— | O | C═O | H | H | Cl | H | H | H | 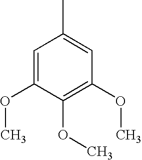 | 388 (MH⁺, 15)/4.96 min |
| 11 | —CH₂— | O | C═O | H | H | H | Cl | H | H | 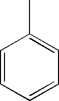 | 298 (MH⁺, 100)/5.31 min |
| 12 | —CH₂— | O | C═O | H | H | —O—CH₂—O— | — | H | H | 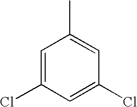 | 376 (MH⁺, 100)/5.77 min |
| 13 | —CH₂— | O | C═O | H | H | —O—CH₂—O— | — | H | H | 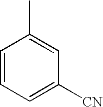 | 333 (MH⁺, 100)/4.35 min |
| 14 | —CH₂— | O | C═O | H | H | —O—CH₂—O— | — | H | H | 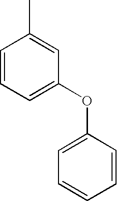 | 400 (MH⁺, 100)/5.84 min |
| 15 | —CH₂— | O | C═O | H | H | —O—CH₂—O— | — | H | H | 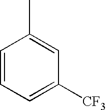 | 376 (MH⁺, 100)/5.38 min |
| 16 | —CH₂— | O | C═O | H | H | —O—CH₂—O— | — | H | H | 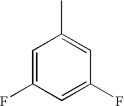 | 344 (MH⁺, 100)/4.99 min |
| 17 | —CH₂— | O | C═O | H | H | —O—CH₂—O— | — | H | H | 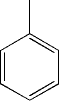 | 308 (MH⁺, 100)/4.59 min |
| 18 | —CH₂— | O | C═O | H | H | —O—CH₂—O— | — | H | H | 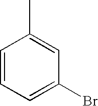 | 386 (MH⁺, 100)/5.22 min |
| 19 | —CH₂— | O | C═O | H | H | —O—CH₂—O— | — | H | H | 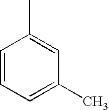 | 322 (MH⁺, 100)/4.96 min |
| 20 | —CH₂— | O | C═O | H | H | —O—CH₂—O— | — | H | H | 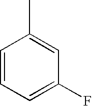 | 326 (MH⁺, 100)/4.75 min |
| 21 | —CH₂— | O | C═O | H | H | —O—CH₂—O— | — | H | H | 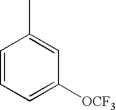 | 392 (MH⁺, 100)/5.56 min |
| 22 | —CH₂— | O | C═O | H | H | —O—CH₂—O— | — | H | H | 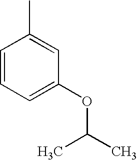 | 366 (MH⁺, 100)/5.33 min |
| 23 | —CH₂— | O | C═O | H | H | —O—CH₂—O— | — | H | H | 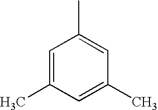 | 336 (MH⁺, 100)/5.34 min |
| 24 | —CH₂— | O | C═O | H | H | H | Cl | H | H | 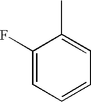 | 316 (MH⁺, 100)/5.40 min |
| 25 | —CH₂— | O | C═O | H | H | H | Cl | H | H | 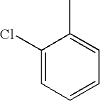 | 332 (MH⁺, 100)/5.77 min |
| 26 | —CH₂— | O | C═O | H | H | H | Cl | H | H | 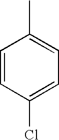 | 332 (MH⁺, 100)/5.99 min |
| 27 | —(CH₂)₂— | —CH₂— | C═O | H | H | —O—CH₂—O— | — | H | H | 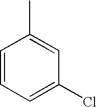 | 354 (MH⁺, 100)/5.20 min |
| 28 | —CH₂— | —CH₂— | C═O | H | H | —O—CH₂—O— | — | H | H | 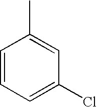 | 340 (MH⁺, 100)/4.76 min |
| 29 | —(CH₂)₂— | CH₂ | —CH₂— | H | H | —O—CH₂—O— | — | H | H | 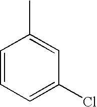 | 338 (MH⁺, 100)/5.24 min |
| 30 | —CH₂— | CH₂ | —CH₂— | H | H | —O—CH₂—O— | — | H | H | 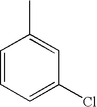 | 324 (MH⁺, 100)/4.98 min |
| 31 | —CH₂C(CH₃)₂— | —CH₂— | C═O | H | H | —O—CH₂—O— | — | H | H | 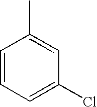 | 382 (MH⁺, 100)/5.84 min |
| 32 | —CH₂— | O | C═O | H | H | Cl | H | H | CH₃ | 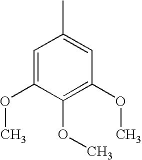 | 402 (MH⁺, 10)/5.29 min |
| 33 | —CH₂— | O | C═O | H | H | H | Cl | H | CH₃ | 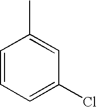 | 346 (MH⁺, 100)/6.29 min |
| 34 | —C(CH₃)₂CH₂— | O | C═O | H | H | —O—CH₂—O— | — | H | H | 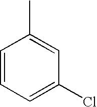 | 384 (MH⁺, 100)/5.71 min |
| 35 | —CH₂CH(CH₃)— | O | C═O | H | H | —O—CH₂—O— | — | H | H | 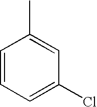 | 370 (MH⁺, 100)/5.30 min |
| 36 | —C(CH₃)₂O— | N—CH₃ | C═O | H | H | —O—CH₂—O— | — | H | H | 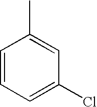 | 399 (MH⁺, 100)/5.78 min |
| 37 | —C(CH₃)₂CH₂— | O | —SO₂— | H | H | —O—CH₂—O— | — | H | H | 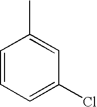 | 420 (MH⁺, 100)/6.05 min |
| 38 | —CH(CH₃)— | O | C═O | H | H | —O—CH₂—O— | — | H | H | 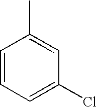 | 356 (MH⁺, 100)/5.37 min |
| 39 | —C(CH₃)₂— | O | —SO₂— | H | H | —O—CH₂—O— | — | H | H | 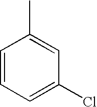 | 406 (MH⁺, 100)/5.88 min |
| 40 | —C(CH₃)₂— | NH | C═O | H | H | —O—CH₂—O— | — | H | H | 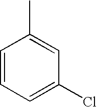 | 369 (MH⁺, 100)/4.85 min |
| 41 | —C(CH₃)₂CH₂— | O | C═O | H | H | —O—CH₂—O— | — | H | H | 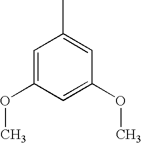 | 410 (MH⁺, 100)/5.09 min |
| 42 | —CH₂CH(CH₃)— | O | C═O | H | H | —O—CH₂—O— | — | H | H | 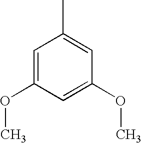 | 396 (MH⁺, 100)/4.72 and 4.81 min |
| 43 | —C(CH₃)₂— | O | —(CO)—N(CH₃)— | H | H | —O—CH₂—O— | — | H | H | 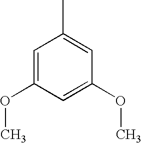 | 425 (MH⁺, 100)/5.31 min |
| 44 | —C(CH₃)₂CH₂— | O | —SO₂— | H | H | —O—CH₂—O— | — | H | H | 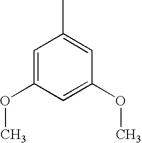 | 446 (MH⁺, 100)/5.54 min |
| 45 | —CH(CH₃)— | O | C═O | H | H | —O—CH₂—O— | — | H | H | 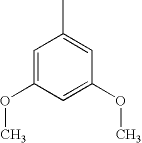 | 382 (MH⁺, 100)/4.87 min |
| 46 | —C(CH₃)₂— | O | —SO₂— | H | H | —O—CH₂—O— | — | H | H | 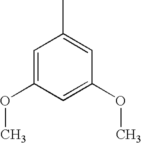 | 432 (MH⁺, 100)/5.42 min |
| 47 | —C(CH₃)₂— | NH | C═O | H | H | —O—CH₂—O— | — | H | H | 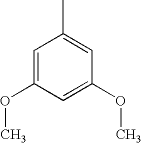 | 395 (MH⁺, 100)/4.37 min |
| 48 | —CH₂— | N-i-Pr | C═O | H | H | —O—CH₂—O— | — | H | H | 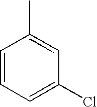 | 383 (MH⁺, 100)/5.33 min |
| 49 | 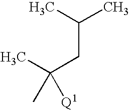 | NH | C═O | H | H | —O—CH₂—O— | — | H | H | 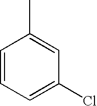 | 411 (MH⁺, 100)/5.59 min |
| 50 | —C(CH₃)₂— | O | C═O | H | H | —O—CH₂—O— | — | H | H | 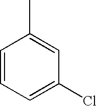 | 370 (MH⁺, 100)/5.59 min |
| 51 | 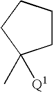 | O | C═O | H | H | —O—CH₂—O— | — | H | H | 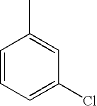 | 369 (MH⁺, 100)/6.05 min |
| 52 | 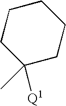 | O | C═O | H | H | —O—CH₂—O— | — | H | H | 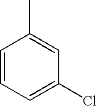 | 410 (MH⁺, 100)/6.33 min |
| 53 | —CH₂— | O | C═O | H | H | H | Cl | H | H | 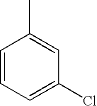 | 332 (MH⁺, 100)/5.83 min |
| 54 | —(CH₂)₂— | CH₂ | C═O | H | H | —O—CH₂—O— | — | H | H | 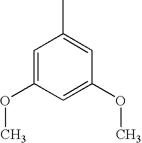 | 380 (MH⁺, 100)/4.58 min |
| 55 | —CH₂C(CH₃)₂— | CH₂ | C═O | H | H | —O—CH₂—O— | — | H | H | 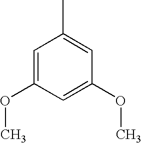 | 408 (MH⁺, 100)/5.18 min |
| 56 | —CH₂— | CH₂ | C═O | H | H | —O—CH₂—O— | — | H | H | 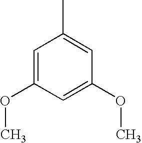 | 366 (MH⁺, 100)/4.27 min |
| 57 | —CH₂— | CH₂ | —CH₂— | H | H | —O—CH₂—O— | — | H | H | 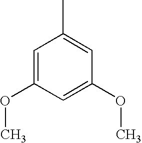 | 352 (MH⁺, 100)/7.36 min |
| 58 | 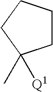 | O | C═O | H | H | —O—CH₂—O— | — | H | H | 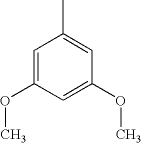 | 422 (MH⁺, 100)/5.47 min |
| 59 | —CH₂— | N-i-Pr | C═O | H | H | —O—CH₂—O— | — | H | H | 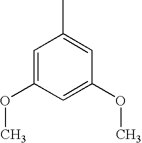 | 409 (MH⁺, 100)/4.83 min |
| 60 | 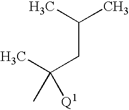 | NH | C═O | H | H | —O—CH₂—O— | — | H | H | 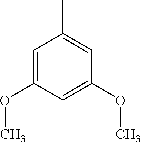 | 437 (MH⁺, 100)/5.15 min |
| 61 | —CH₂— | O | C═O | H | H | —O—CH₂—O— | — | H | H | 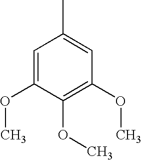 | 398 (MH⁺, 30)/4.14 min |
| 62 | —CH₂— | O | C═O | CH₃ | H | CH₃ | H | H | H | 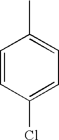 | 326 (MH⁺, 100)/6.14 min |
| 63 | —CH₂— | O | C═O | H | H | OCH₃ | OCH₃ | H | H | 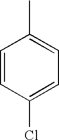 | 358 (MH⁺, 100)/4.81 min |
| 64 | —CH₂— | O | C═O | H | H | Cl | H | H | H | 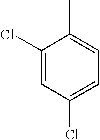 | 366 (MH⁺, 100)/6.55 min |
| 65 | —CH₂— | O | C═O | H | H | Cl | H | H | H | 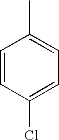 | 332 (MH⁺, 100)/5.87 min |
| 66 | —CH₂— | O | C═O | H | H | Cl | H | H | H | 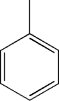 | 298 (MH⁺, 100)/5.27 min |
| 67 | —CH₂— | O | C═O | H | H | —O—CH₂—O— | — | H | H | 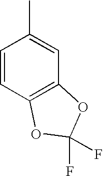 | 388 (MH⁺, 100)/5.48 min |
| 68 | —CH₂— | O | C═O | H | H | OCH₃ | OCH₃ | H | H | 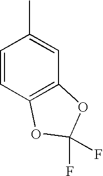 | 404 (MH⁺, 100)/5.13 min |
| 69 | —CH₂— | O | C═O | CH₃ | H | —O—CH₂—O— | — | H | H | 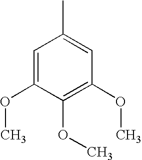 | 412 (MH⁺, 100)/4.47 min |
| 70 | —CH₂— | O | C═O | H | H | —O—CF₂—O— | — | H | H | 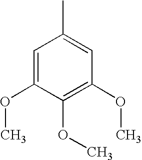 | 434 (MH⁺, 10)/5.16 min |
| 71 | —CH₂— | O | C═O | CH₃ | H | OCH₃ | OCH₃ | H | H | 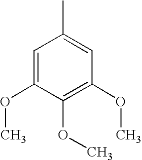 | 414 (MH⁺, 60)/3.62 min |
| 72 | —CH₂— | O | C═O | H | H | OCH₃ | OCH₃ | H | H | 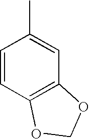 | 368 (MH⁺, 100)/4.08 min |
| 73 | —CH₂— | O | C═O | H | H | OCH₃ | OCH₃ | H | H | 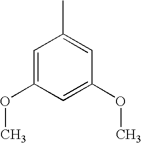 | 384 (MH⁺, 100)/4.15 min |
| 74 | —CH₂— | O | C═O | H | H | —O—(CH₂)₂—O— | — | H | H | 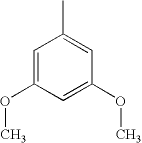 | 382 (MH⁺, 100)/4.43 min |
| 75 | —CH₂— | O | C═O | H | H | —O—(CH₂)₃—O— | — | H | H | 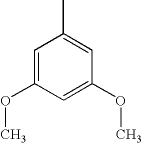 | 396 (MH⁺, 100)/4.63 min |
| 76 | —CH₂— | O | C═O | H | H | —O—CF₂—O— | — | H | H | 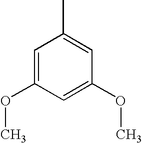 | 396 (MH⁺, 100)/4.63 min |
| 77 | —CH₂— | O | C═O | H | H | OEt | H | H | H | 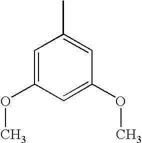 | 396(MH⁺, 100)/4.63 min |
| 78 | —CH₂— | O | C═O | H | H | OCF₃ | H | H | H | 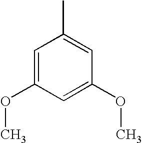 | 408 (MH⁺, 100)/5.32 min |
| 79 | —CH₂— | O | C═O | H | H | OCH₃ | OCH₃ | OCH₃ | H | 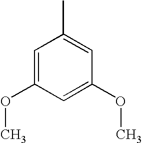 | 414 (MH⁺, 100)/4.62 min |
| 80 | —CH₂— | O | C═O | H | H | OBn | H | H | H | 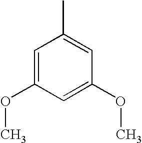 | 430 (MH⁺, 100)/5.42 min |
| 81 | —CH₂— | O | C═O | H | H | OEt | OEt | H | H | 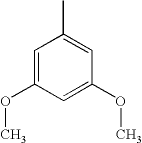 | 412 (MH⁺, 100)/5.08 min |
| 82 | —CH₂— | O | C═O | H | H | OPh | H | H | H | 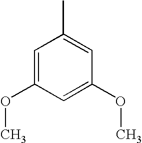 | 416 (MH⁺, 100)/6.05 min |
| 83 | —CH₂— | O | C═O | H | H | CH₃ | H | CH₃ | H | 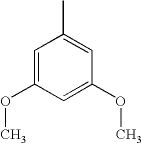 | 352 (MH⁺, 100)/5.55 min |
| 84 | —CH₂— | O | C═O | H | H | SCH₃ | H | H | H | 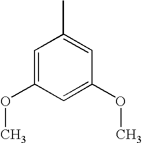 | 370 (MH⁺, 100)/5.21 min |
| 85 | —CH₂— | O | C═O | H | H | ^{t}Bu | H | H | H | 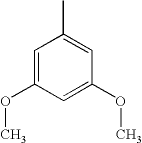 | 380 (MH⁺, 100)/5.65 min |
| 86 | —CH₂— | O | C═O | H | H | H | OCH₃ | H | H | 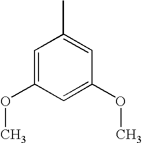 | 354 (MH⁺, 100)/4.54 min |
| 87 | —CH₂— | O | C═O | H | H | H | OiPr | H | H | 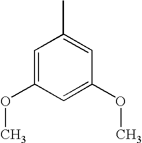 | 382 (MH⁺, 100)/5.33 min |
| 88 | —CH₂— | O | C═O | H | H | OCH₂F | OCH₂F | H | H | 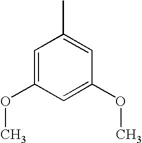 | 456 (MH⁺, 100)/5.42 min |
| 89 | —CH₂— | O | C═O | H | H | OiPr | H | H | H | 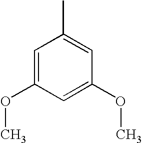 | 382 (MH⁺, 100)/5.49 min |
| 90 | —CH₂— | O | C═O | H | OCH₃ | OCH₃ | H | H | H | 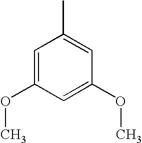 | 384 (MH⁺, 100)/4.84 min |
| 91 | —CH₂— | O | C═O | H | H | CH₃ | CH₃ | H | H | 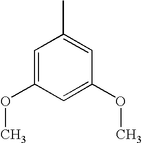 | 352 (MH⁺, 100)/5.37 min |
| 92 | —CH₂— | O | C═O | H | H | Ph | H | H | H | 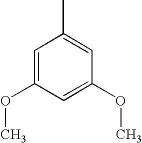 | 400 (MH⁺, 100)/5.99 min |
| 93 | —CH₂— | O | C═O | H | H | OCH₃ | CH₃ | H | H | 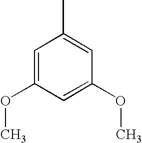 | 368 (MH⁺, 100)/5.19 min |
| 94 | —CH₂— | O | C═O | H | H | OCH₃ | Cl | H | H | 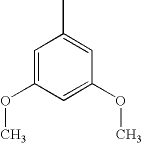 | 388 (MH⁺, 100)/5.16 min |
| 95 | —CH₂— | O | C═O | Et | H | 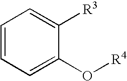 | — | H | H | 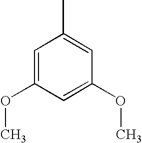 | 414 (MH⁺, 100)/5.84 min |
| 96 | —CH₂— | O | C═O | H | H | OBn | Br | H | H | 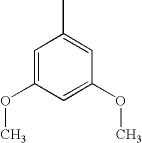 | 510 (MH⁺, 100)/6.50 min |
| 97 | —CH₂— | O | C═O | Et | H | OCH₃ | OCH₃ | H | H | 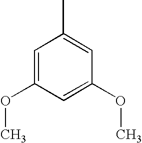 | 412 (MH⁺, 100)/4.44 min |
| 98 | —CH₂— | O | C═O | Et | H | —O—CH₂—O— | — | | H | 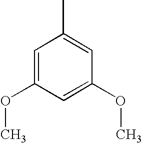 | 396 (MH⁺, 100)/4.82 min |
| 99 | —CH₂— | O | C═O | H | H | OEt | CH₃ | H | H | 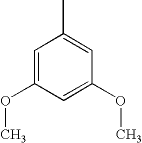 | 382 (MH⁺, 100)/5.26 min |
| 100 | —CH₂— | O | C═O | H | H | OCH₃ | H | OCH₃ | H | 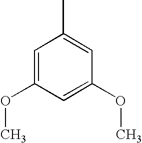 | 384 (MH⁺, 100)/4.20 min |
| 101 | —CH₂— | O | C═O | H | H | OEt | H | H | H | 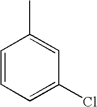 | |
| 102 | —CH₂— | O | C═O | H | H | OEt | H | H | H | 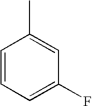 | |
| 103 | —CH₂— | O | C═O | H | H | OEt | H | H | H | 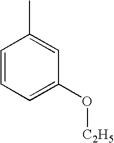 | 352 (MH⁺, 100)/4.97 min |
| 104 | —CH₂— | O | C═O | H | H | OH | H | H | H | 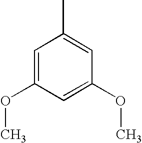 | 340 (MH⁺, 100)/3.34 min |
| 105 | —CH₂— | O | C═O | H | H | OEt | H | H | H | 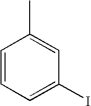 | |
| 106 | —CH₂— | O | C═O | H | H | OEt | H | H | H | 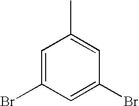 | |
| 107 | —CH₂— | O | C═O | H | H | —O—CH₂—O— | — | H | CH₃ | 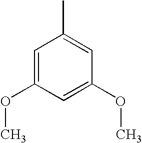 | 382 (MH⁺, 100)/4.76 min |
| 108 | —CH₂— | O | C═O | H | H | —O—CH₂—O— | — | H | H | 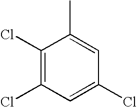 | 410 (MH⁺, 100)/6.09 min |
| 109 | —CH₂— | O | C═O | H | H | —O—CH₂—O— | — | H | H | 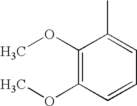 | 368 (MH⁺, 100)/4.62 min |
| 110 | —CH₂— | O | C═O | H | H | —O—CH₂—O— | — | H | H | 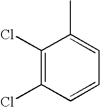 | 376 (MH⁺, 100)/5.49 min |
| 111 | —CH₂— | O | C═O | H | H | —O—CH₂—O— | — | H | H | 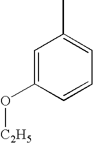 | 352 (MH⁺, 100)/4.99 min |
| 112 | —CH₂— | O | C═O | H | H | —O—CH₂—O— | — | H | H | 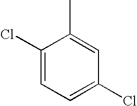 | 376 (MH⁺, 100)/5.49 min |
| 113 | —CH₂— | O | C═O | H | H | —O—CH₂—O— | — | H | H | 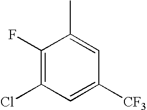 | 428 (MH⁺, 100)/5.99 min |
| 114 | —CH₂— | O | C═O | H | H | —O—CH₂—O— | — | H | H | 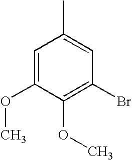 | 446 (MH⁺, 100)/5.05 min |
| 115 | —CH₂— | O | C═O | H | H | —O—CH₂—O— | — | H | H | 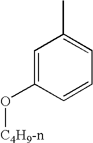 | 380 (MH⁺, 100)/5.96 min |
| 116 | —CH₂— | O | C═O | H | H | —O—CH₂—O— | — | H | H | 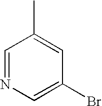 | 387 (MH⁺, 100)/4.04 min |
| 117 | —CH₂— | O | C═O | H | H | —O—CH₂—O— | — | H | H | 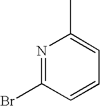 | 387 (MH⁺, 100)/4.39 min |
| 118 | —CH₂— | O | C═O | H | H | —O—CH₂—O— | — | H | H | 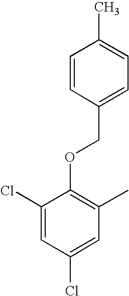 | 496 (MH⁺, 100)/7.45 min |
| 119 | —CH₂— | O | C═O | H | H | —O—CH₂—O— | — | H | H | 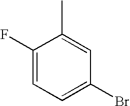 | 404 (MH⁺, 100)/5.25 min |
| 120 | —CH₂— | O | C═O | H | H | —O—CH₂—O— | — | H | H | 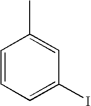 | 434 (MH⁺, 100)/5.36 min |
| 121 | —CH₂— | O | C═O | H | H | —O—CH₂—O— | — | H | H | 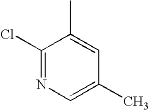 | 357 (MH⁺, 100)/4.13 min |
| 122 | —CH₂— | O | C═O | H | H | —O—CH₂—O— | — | H | H | 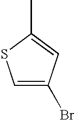 | 392 (MH⁺, 40)/5.09 min |
| 123 | —CH₂— | O | C═O | H | H | —O—CH₂—O— | — | H | H | 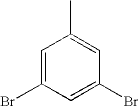 | 464 (MH⁺, 55)/5.96 min |
| 124 | —CH₂— | O | C═O | H | H | —O—CH₂—O— | — | H | H | 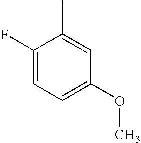 | 356 (MH⁺, 100)/4.70 min |
| 125 | —CH₂— | O | C═O | H | H | —O—CH₂—O— | — | H | H | 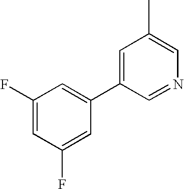 | 421 (MH⁺, 100)/4.50 min |
| 126 | —CH₂— | O | C═O | H | H | —O—CH₂—O— | — | H | H | 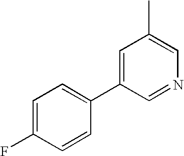 | 401 (MH⁺, 100)/5.03 min |
| 127 | —CH₂— | O | C═O | H | H | —O—CH₂—O— | — | H | H | 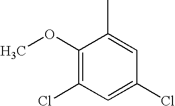 | 406 (MH⁺, 100)/5.95 min |
| 128 | —CH₂— | O | C═O | H | H | —O—CH₂—O— | — | H | H | 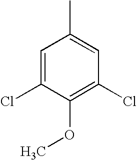 | 406 (MH⁺, 100)/5.55 min |
| 129 | —CH₂— | O | C═O | H | H | —O—CH₂—O— | — | H | H | 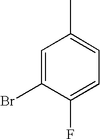 | 404 (MH⁺, 100)/5.30 min |
| 130 | —CH₂— | O | C═O | H | H | —O—CH₂—O— | — | H | H | 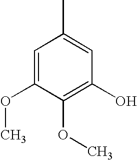 | 384 (MH⁺, 100)/3.67 min |
| 131 | —CH₂— | O | C═O | H | H | —O—CH₂—O— | — | H | H | 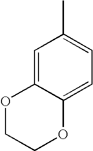 | 366 (MH⁺, 100)/4.39 min |
| 132 | —CH₂— | O | C═O | H | H | —O—CH₂—O— | — | H | H | 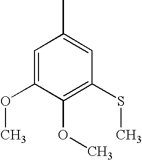 | 414 (MH⁺, 50)/4.85 min |
| 133 | —CH₂— | O | C═O | H | H | —O—CH₂—O— | — | H | H | 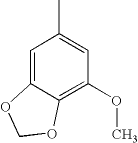 | 382 (MH⁺, 100)/4.93 min |
| 134 | —CH₂— | O | C═O | H | H | —O—CH₂—O— | — | H | H | 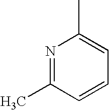 | 323 (MH⁺, 100)/1.90 min |
| 135 | —CH₂— | O | C═O | H | H | —O—CH₂—O— | — | H | H | 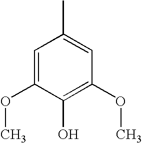 | 384 (MH⁺, 7)/3.49 min |
| 136 | —CH₂— | O | C═O | H | H | —O—CH₂—O— | — | H | H | 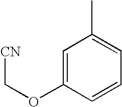 | 363 (MH⁺, 100)/4.30 min |
| 137 | —CH₂— | O | C═O | H | H | —O—CH₂—O— | — | H | H | 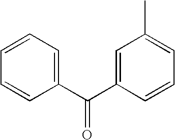 | 412 (MH⁺, 100)/5.22 min |
| 138 | —CH₂— | O | C═O | H | H | —O—CH₂—O— | — | H | H | 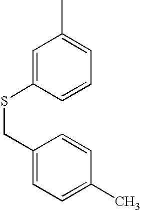 | 444 (MH⁺, 100)/6.32 min |
| 139 | —CH₂— | O | C═O | H | H | —O—CH₂—O— | — | H | H | 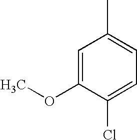 | 372 (MH⁺, 100)/4.94 min |
| 140 | —CH₂— | O | C═O | H | H | —O—CH₂—O— | — | H | H | 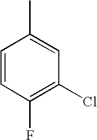 | 360 (MH⁺, 100)/5.14 min |
| 141 | —CH₂— | O | C═O | H | H | —O—CH₂—O— | — | H | H | 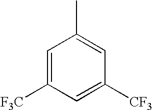 | 444 (MH⁺, 100)/6.07 min |
| 142 | —CH₂— | O | C═O | H | H | —O—CH₂—O— | — | H | H | 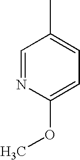 | 339 (MH⁺, 100)/3.69 min |
| 143 | —CH₂— | O | C═O | H | H | —O—CH₂—O— | — | H | H | 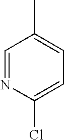 | 343 (MH⁺, 100)/3.98 min |
| 144 | —CH₂— | O | C═O | H | H | —O—CH₂—O— | — | H | H | 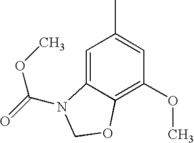 | 439 (MH⁺, 100)/4.39 min |
| 145 | —CH₂— | O | C═O | H | H | —O—CH₂—O— | — | H | H | 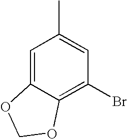 | 430 (MH⁺, 100)/4.97 min |
| 146 | —CH₂— | O | C═O | H | H | —O—CH₂—O— | — | H | H | 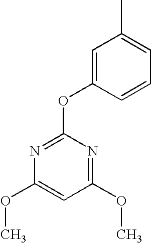 | 462 (MH⁺, 100)/5.25 min |
| 147 | —CH₂— | O | C═O | H | H | —O—CH₂—O— | — | H | H | 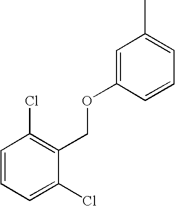 | 482 (MH⁺, 100)/6.22 min |
| 148 | —CH₂— | O | C═O | H | H | —O—CH₂—O— | — | H | H | 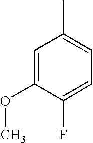 | 356 (MH⁺, 100)/4.55 min |
| 149 | —CH₂— | O | C═O | H | H | —O—CH₂—O— | — | H | H | 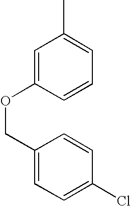 | 448 (MH⁺, 100)/6.19 min |
| 150 | —CH₂— | O | C═O | H | H | —O—CH₂—O— | — | H | H | 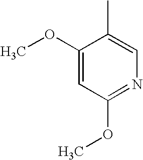 | 369 (MH⁺, 100)/2.84 min |
| 151 | —CH₂— | O | C═O | H | H | —O—CH₂—O— | — | H | H | 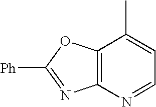 | 426 (MH⁺, 100)/4.26 min |
| 152 | —CH₂— | O | C═O | H | H | —O—CH₂—O— | — | H | H | 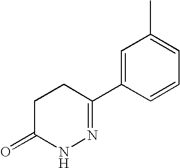 | 404 (MH⁺, 100)/3.56 min |
| 153 | —CH₂— | O | C═O | H | H | —O—CH₂—O— | — | H | H | 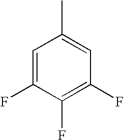 | 362 (MH⁺, 100)/5.15 min |
| 154 | —CH₂— | O | C═O | H | H | —O—CH₂—O— | — | H | H | 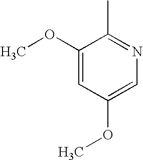 | 369 (MH⁺, 100)/3.26 min |
| 155 | —CH₂— | O | C═O | H | H | —O—CH₂—O— | — | H | H | 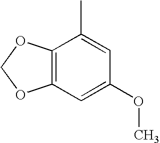 | 382 (MH⁺, 100)/4.35 min |
| 156 | —CH₂— | O | C═O | H | H | —O—CH₂—O— | — | H | H | 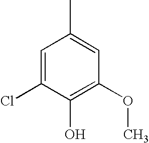 | 388 (MH⁺, 100)/4.01 min |
| 157 | —CH₂— | O | C═O | H | H | —O—CH₂—O— | — | H | H | 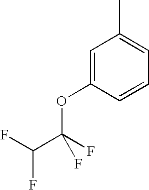 | 424 (MH⁺, 100)/5.37 min |
| 158 | —CH₂— | O | C═O | H | H | —O—CH₂—O— | — | H | H | 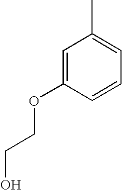 | 368 (MH⁺, 100)/3.58 min |
| 159 | —CH₂— | O | C═O | H | H | —O—CH₂—O— | — | H | H | 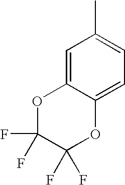 | 420 (MH⁺, 100)/5.26 min |
| 160 | —CH₂— | O | C═O | H | H | —O—CH₂—O— | — | H | H | 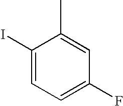 | 452 (MH⁺, 100)/5.32 min |
| 161 | —CH₂— | O | C═O | H | H | OCH₃ | H | H | H | 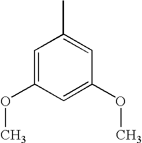 | 354 (MH⁺, 100)/4.77 min |
| 162 | —CH₂— | O | C═O | H | H | H | OCH₃ | H | H | 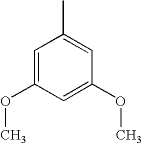 | 354 (MH⁺, 100)/4.63 min |
| 163 | —CH₂— | O | C═O | H | H | —O—CH₂—O— | — | H | H | 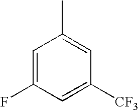 | 394 (MH⁺, 100)/5.53 min |
| 164 | —CH₂— | O | C═O | H | H | —O—CH₂—O— | — | H | H | 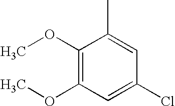 | 402 (MH⁺, 100)/5.15 min |
| 165 | —CH₂— | O | C═O | H | H | CH₃ | H | H | H | 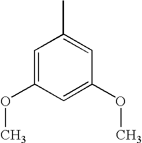 | 338 (MH⁺, 100)/5.09 min |

[a] The physical data reported relate to LC-MS measurements: m/z (%)/Rₜ. The measurements were made on an Agilent LC/MSD, consisting of an Agilent HPLC 1100 unit with vacuum devolatilizer, binary pump, column oven, and diode array detector (DAD) and an LC-MSD detector with ESI ion source. Analytical column: dimensions: 70×3.1 mm, column material: Kromasil C18, particle size: 3.5 μm. Mobile phase A: 0.1% formic acid in water; mobile phase B: acetonitrile. Gradient: start conditions: 90% A/10% B; the acetonitrile, fraction (B) is raised 10%/min up to 5% A/95% B; there after a further 5 min at 5% A/95% B.

Some of the compounds of the general formula (I) for inventive use are already known (cf. the literature cited as an introduction above).

In some cases, however, the compounds of the general formula (I) for inventive use are not yet known from the literature.

The preparation of the new and of the known compounds of the formula (I) can be sketched as follows:
(a) Reaction of aniline derivatives of the formula (II) with carbonyl compounds of the formula (III) and cyclic enols of the formula (IV) in a three-component reaction in the presence of a diluent or reaction auxiliary, such as methanol, ethanol, acetic acid, methanesulfonic acid or trifluoroacetic acid, at temperatures between 0° C. and 150° C., in accordance with the following formula scheme (cf. Organic Letters 4 (2002), 3187-3189; EP-1103554, WO-2002/094835, WO-2002/094840; preparation examples):

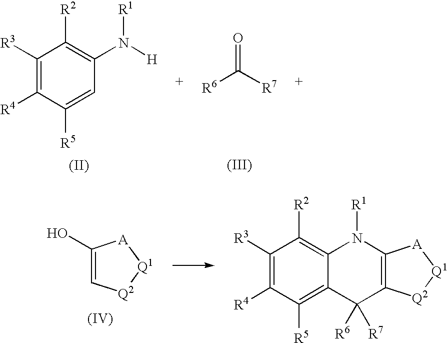

(b) Reaction of aniline derivatives of the formula (II) with carbonyl compounds of the formula (V) in a two-component reaction in accordance with the following formula scheme (cf. EP-1103554):

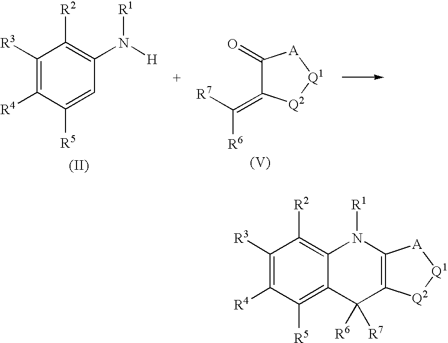

(c) Reduction of quinoline derivatives of the formula (VI) with suitable hydrogenating agents, such as sodium cyanoborohydride, in the presence of diluents or reaction auxiliaries, such as acetic acid, at temperatures between 0° C. and 50° C., in accordance with the following formula scheme (cf. Bioorg. & Med. Chem. Lett. 10 (2000), 315-317; Chemistry Express 8 (1993), 389-392; preparation examples):

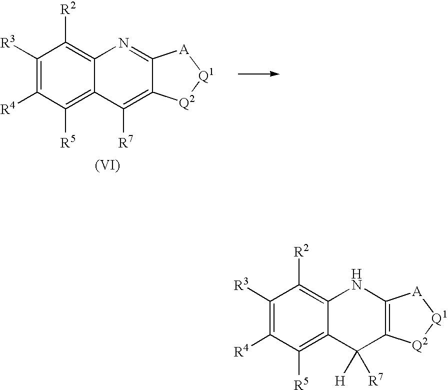

(d) Reaction of hydroxyalkylanilines of the formula (VII) with cyclic enols of the formula (IV) in the presence of a diluent, such as toluene, and optionally in the presence of a reaction auxiliary, such as p-toluenesulfonic acid, at temperatures between 0° C. and 150° C., in accordance with the following formula scheme (cf. the preparation examples):

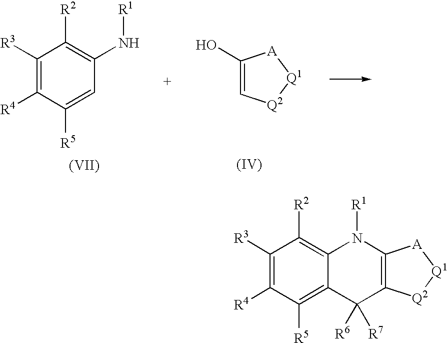

The annulated quinoline derivatives of the formula (I) are well tolerated by plants, have favorable homeotherm toxicity and are environmentally friendly, they are suitable for protecting plants and plant organs, for increasing harvest yields, for improving the quality of the harvested material and for controlling animal pests, in particular insects, arachnids and nematodes encountered in agriculture, in forests, in gardens and leisure facilities, in the protection of stored products and materials and in the hygiene sector. They may preferably be used as crop protection agents. They are active against normally sensitive and resistant species and against all or some stages of development. The abovementioned pests include:

From the order of the Isopoda, for example, Oniscus asellus, Armadillidium vulgare and Porcellio scaber.

From the order of the Diplopoda, for example, Blaniulus guttulatus.

From the order of the Chilopoda, for example, Geophilus carpophagus and Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp. and Schistocerca gregaria.

From the order of the Blattaria, for example, Blatta orientalis, Periplaneta americana, Leucophaea maderae and Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp., Damalinia spp.

From the order of the Thysanoptera, for example, Hercinothrips femoralis, Thrips tabaci, Thrips palmi, Frankliniella accidentalis.

From the order of the Heteroptera, for example, Eurygaster spp., Dysdercus intermedius, Piesma quadrata, Cimex lectularius, Rhodnius prolixus and Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp.

From the order of the Lepidoptera, for example, Pectinophora gossypiella, Bupalus pinarius, Cheimatobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp. and Oulema oryzae.

From the order of the Coleoptera, for example, Anobium punctatum, Rhizopertha dominica, Bruchidius obtectus, Acanthoscelides obtectus, Hylotrupes bajulus, Agelastida alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica and Lissorhoptrus oryzophilus.

From the order of the Hymenoptera, for example, Diprion spp., Hoplocampa spp., Lasius spp., Monomorium pharaonis and Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp. and Liriomyza spp.

From the order of the Siphonaptera, for example, Xenopsylla cheopis and Ceratophyllus spp.

From the order of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp, Rhipicephalus spp., Amblyomma spp., Hyalomma spp., Ixodes spp., Psoroptes spp. Chorioptes spp., Sarcoptes spp., Tarsonemus spp., Bryobia praetiosa, Panonychus spp., Tetranychus spp., Hemitarsonemus spp. and Brevipalpus spp.

The plant-parasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp. and Bursaphelenchus spp.

The compounds of the formula (I) according to the invention are notable in particular for a strong effect against beetles and their larvae (e.g. Phaedon cochleariae), butterflies and their larvae or caterpillars (e.g. Heliothis virescens, Plutella xylostella, Spodoptera exigua, Spodoptera frugiperda), spider mites (e.g. Tetranychus urticae), and nematodes (e.g. Meloidogyne incognita).

If appropriate, the compounds according to the invention may also be used in certain concentrations or application rates as herbicides or as safeners for them, or as microbicides, for example as fungicides, antimycotics and bactericides. If appropriate, they can also be employed as intermediates or precursors for the synthesis of further active compounds.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and recombinant methods or by combinations of these methods, including the transgenic plants and inclusive of the plant cultivars protectable or not protectable by varietal property rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

The treatment according to the invention of the plants and plant parts with the active compounds is carried out directly or by allowing the compounds to act on their surroundings, environment or storage space by the customary treatment methods, for example by immersion, spraying, evaporation, fogging, scattering, spreading or injecting and, in the case of propagation material, in particular in the case of seeds, also by applying one or more coats.

The active compounds can be converted into the customary formulations such as solutions, emulsions, wettable powders, suspensions, powders dusts, pastes, soluble powders, granules, suspension-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants, and/or foam formers.

If the extender used is water, it is also possible, for example, to use organic solvents as cosolvents. The following are essentially suitable as liquid solvents: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Suitable solid carriers are:

for example ammonium salts and ground natural minerals such as kaolins, clays, talc, chalk, quartz, attapulgite, montmorillonite or diatomaceous earth, and ground synthetic materials such as highly-disperse silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates; suitable dispersants are: for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other additives can be mineral and vegetable oils.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally contain between 0.1% and 95% by weight of active compound, preferably between 0.5% and 90%.

The active compound according to the invention may be present in its commercially customary formulations, and in the application forms prepared from these formulations, as mixtures with other active compounds, such as insecticides, attractants, sterilants, bactericides, acaricides, nematicides, fungicides, growth regulators or herbicides. The insecticides include, for example, phosphates, carbamates, carboxylates, chlorinated hydrocarbons, phenylureas, substances produced by microorganisms, etc.

Particularly favorable cocomponents in the mixtures are, for example, the following:

### Fungicides:

2-phenylphenol; 8-hydroxyquinoline sulfate; acibenzolar-S-methyl; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; bilanafos; binapacryl; biphenyl; bitertanol; blasticidin-S; bromuconazole; bupirimate; buthiobate; butylamine; calcium polysulfide; capsimycin; captafol; captan; carbendazim; carboxin; carpropamid; carvone; chinomethionat; chlobenthiazone; chlorfenazole; chloroneb; chlorothalonil; chlozolinate; clozylacon; cyazofamid; cyflufenamid; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-M; dinocap; diphenylamine; dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; fluprimidol; flusilazole; flusulfamide; flutolanil; flutriafol; folpet; fosetyl-Al; fosetyl-sodium; fuberidazole; furalaxyl; furametpyr; furcarbanil; furmecyclox; guazatine; hexachlorobenzene; hexaconazole; hymexazole; imazalil; imibenconazole; iminoctadine triacetate; iminoctadine tris(albesilate); iodocarb; ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M; metconazole; methasulfocarb; methfuroxam; metiram; metominostrobin; metsulfovax; mildiomycin; myclobutanil; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthiin; paclobutrazole; pefurazoate; penconazole; pencycuron; phosdiphen; phthalide; picoxystrobin; piperalin; polyoxins; polyoxorim; probenazole; prochloraz; procymidone; propamocarb; propanosine-sodium; propiconazole; propineb; proquinazid; prothioconazole; pyraclostrobin; pyrazophos; pyrifenox; pyrimethanil; pyroquilon; pyroxyfur; pyrrolenitrine; quinconazole; quinoxyfen; quintozene; simeconazole; spiroxamine; sulfur; tebuconazole; tecloftalam; tecnazene; tetcyclacis; tetraconazole; thiabendazole; thicyofen; thifluzamide; thiophanate-methyl; thiram; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin, A; vinclozolin; zineb; ziram; zoxamide; (2S)—N-[2-[4-[[3-(4-chlorophenyl)-2-propynyl]oxy]-3-methoxyphenyl]ethyl]-3-methyl-2-[(methylsulfonyl)amino]butanamide; 1-(1-naphthalenyl)-1H-pyrrole-2,5-dione; 2,3,5,6-tetrachloro-4-(methylsulfonyl)pyridine; 2-amino-4-methyl-N-phenyl-5-thiazolecarboxamide; 2-chloro-N-(2,3-dihydro-1,1,3-trimethyl-1H-inden-4-yl)-3-pyridinecarboxamide; 3,4,5-trichloro-2,6-pyridinedicarbonitrile; actinovate; cis-1-(4-chlorophenyl)-2-(1H-1,2,4-triazol-1-yl)cycloheptanol; methyl 1-(2,3-dihydro-2,2-dimethyl-1H-inden-1-yl)-1H-imidazole-5-carboxylate; monopotassium carbonate; N-(6-methoxy-3-pyridinyl)cyclopropanecarboxamide; N-butyl-8-(1,1-dimethylethyl)-1-oxaspiro[4.5]decane-3-amine; sodium tetrathiocarbonate;
and copper salts and preparations, such as Bordeaux mixture; copper hydroxide; copper naphthenate; copper oxychloride; copper sulphate; cufraneb; cuprous oxide; mancopper; oxinecopper.

### Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides:

abamectin, ABG-9008, acephate, acequinocyl, acetamiprid, acetoprole, acrinathrin, AKD-1022, AKD-3059, AKD-3088, alanycarb, aldicarb, aldoxycarb, allethrin, alpha-cypermethrin (alphamethrin), amidoflumet, aminocarb, amitraz, avermectin, AZ-60541, azadirachtin, azamethiphos, azinphos-methyl, azinphos-ethyl, azocyclotin,
Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC 11821, baculoviruses, Beauveria bassiana, Beauveria tenella, benclothiaz, bendiocarb, benfuracarb, bensultap, benzoximate, beta-cyfluthrin, beta-cypermethrin, bifenazate, bifenthrin, binapacryl, bioallethrin, bioallethrin-S-cyclopentyl-isomer, bioethanomethrin, biopermethrin, bioresmethrin, bistrifluoron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben,
cadusafos, camphechlor, carbaryl, carbofuran, carbophenothion, carbosulfan, cartap, CGA-50439, chinomethionat, chlordane, chlordimeform, chloethocarb, chlorethoxyfos, chlorfenapyr, chlorfenvinphos, chlorfluazuron, chlormephos, chlorobenzilate, chloropicrin, chlorproxyfen, chlorpyrifos-methyl, chlorpyrifos (-ethyl), chlovaporthrin, chromafenozide, cis-cypermethrin, cisresmethrin, cis-permethrin, clocythrin, chloethocarb, clofentezine, clothianidin, clothiazoben, codlemone, coumaphos, cyanofenphos, cyanophos, cycloprene, cycloprothrin, Cydia pomonella, cyfluthrin, cyhalothrin, cyhexatin, cypermethrin, cyphenothrin (1R-trans-isomer), cyromazine,
DDT, deltamethrin, demeton-S-methyl, demeton-S-methylsulphone, diafenthiuron, dialifos, diazinon, dichlofenthion, dichlorvos, dicofol, dicrotophos, dicyclanil, diflubenzuron, dimefluthrin, dimethoate, dimethylvinphos, dinobuton, dinocap, dinotefuran, diofenolan, disulfoton, docusatsodium, dofenapyn, DOWCO-439,
eflusilanate, emamectin, emamectin-benzoate, empenthrin (1R-isomer), endosulfan, Entomopthora spp., EPN, esfenvalerate, ethiofencarb, ethiprole, ethion, ethoprophos, etofenprox, etoxazole, etrimfos,
famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulfothion, fenthion, fentrifanil, fenvalerate, fipronil, flonicamid, fluacrypyrim, fluazuron, flubenzimine, fluorocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb,
gamma-cyralothrin, gamma-HCH, gossyplure, grandlure, granulosis viruses,
halfenprox, halofenozide, HCH, HCN-801, heptenophos, hexaflumuron, hexythiazox, hydramethylnone, hydroprenz,

### IKA-2002, imidacloprid, imiprothrin, indoxacarb, iodofenphos, iprobenfos, isazofos, isofenphos, isoprocarb, isoxathion, ivermectin,

japonilure,
kadethrin, nuclear polyhedrosis viruses, kinoprene,
lambda-cyhalothrin, lindane, lufenuron,
malathion, mecarbam, mesulfenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metofluthrin, metolcarb, metoxadiazone, mevinphos, milbemectin, milbemycin, MKI-245, MON-45700, monocrotophos, moxidectin, MTI-800,
naled, NC-104, NC-170, NC-184, NC-194, NC-196, niclosamide, nicotine, nitenpyram, nithiazine, NNI-0001, NNI-0101, NNI-0250, NNI-9768, novaluron, noviflumuron,
OK-5101, OK-5201, OK-9601, OK-9602, OK-9701, OK-9802, omethoate, oxamyl, oxydemetonmethyl, Paecilomyces fumosoroseus, parathion-methyl, parathion (-ethyl), permethrin (cis-, trans-), petroleum, PH-6045, phenothrin (1R-trans isomer), phenthoate, phorate, phosalone, phosmet, phosphamidon, phosphocarb, phoxim, piperonyl butoxide, pirimicarb, pirimiphos-methyl, pirimiphos-ethyl, potassium oleate, prallethrin, profenofos, prefluthrin, promecarb, propaphos, propargite, propetamphos, propoxur, prothiofos, prothoate, protrifenbute, pymetrozine, pyraclofos, pyresmethrin, pyrethrum, pyridaben, pyridalyl, pyridaphenthion, pyridathion, pyrimidifen, pyriproxyfen,
quinalphos,
resmethrin, RH-5849, ribavirin, RU-12457, RU-15525,

### S-421, S-1833, salithion, sebufos, SI-0009, silafluofen, spinosad, spirodiclofen, spiromesifen, sulfluramid, sulfotep, sulprofos, SZI-121,

tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (1R-isomer), tetrasul, theta-cypermethrin, thiacloprid, thiamethoxam, thiapronil, thiatriphos, thiocyclam hydrogen oxalate, thiodicarb, thiofanox, thiometon, thiosultap-sodium, thuringiensin, tolfenpyrad, tralocythrin, tralomethrin, transfluthrin, triarathene, triazamate, triazophos, triazuron, trichlophenidine, trichlorfon, Trichoderma atroviride, triflumuron, trimethacarb,
vamidothion, vaniliprole, verbutin, Verticillium lecanii,

### WL-108477, WL40027,

### YI-5201, YI-5301, YI-5302,

### XMC, xylylcarb,

### ZA-3274, zeta-cypermethrin, zolaprofos, ZXI-8901,

the compound 3-methylphenyl propylcarbamate (tsumacide Z),
the compound 3-(5-chloro-3 pyridinyl)-8-(2,2,2-trifluoroethyl)-8-azabicyclo[3.2.1]octane-3-carbonitrile (CAS-Reg. No. 185982-80-3) and the corresponding 3-endo-isomer (CAS-Reg. No. 185984-60-5) (cf. WO-96/37494, WO-98/25923),
and preparations which comprise insecticidally, active plant extracts, nematodes, fungi or viruses.

A mixture with other known active compounds, such as herbicides, or with fertilizers and growth regulators, safeners and/or semiochemicals is also possible.

When used as insecticides in their commercially available formulations and in the use forms prepared with these formulations, the active compounds according to the invention can furthermore be present in the form of a mixture with synergists. Synergists are compounds by which the activity of the active compounds is increased without it being necessary for the synergist added to be active itself.

When used as insecticides in their commercially available formulations and in the use forms prepared with these formulations, the active compounds according to the invention can furthermore be present in the form of a mixture with inhibitors which reduce the degradation of the active compound after application in the habitat of the plant, on the surface of parts of plants or in plant tissues.

The active compound content of the use forms prepared from the commercially available formulations can vary within broad ranges. The active compound concentration of the use forms can be from 0.0000001% up to 95% by weight of active compound, preferably between 0.0001 and 1% by weight.

They are applied in a customary manner adapted to suit the use forms.

When used against hygiene pests and pests of stored products, the active compound is distinguished by excellent residual action on wood and clay as well as good stability to alkali on limed substrates.

As already mentioned above, it is possible to treat all plants or their parts in accordance with the invention. In a preferred embodiment, wild plant species or plant varieties and plant cultivars which have been obtained by traditional biological breeding methods, such as hybridization or protoplast fusion, and the parts of these varieties and cultivars are treated. In a further preferred embodiment, transgenic plants and plant cultivars which have been obtained by recombinant methods, if appropriate in combination with conventional methods (genetic modified organisms), and their parts are treated. The term “parts” or “parts of plants” or “plant parts” has been explained above.

Plants which are treated particularly preferably in accordance with the invention are those of the plant cultivars which are in each case commercially available or in use. Plant cultivars are understood as meaning plants with new traits which have been bred either by conventional breeding, by mutagenesis or by recombinant DNA techniques. They may take the form of cultivars, biotypes and genotypes.

Depending on the plant species or plant cultivars, their location and growth conditions (soils, climate, vegetation period, nutrition), the treatment according to the invention may also result in superadditive (“synergistic”) effects. Thus, for example, reduced application rates and/or a widened activity spectrum and/or an increase in the activity of the substances and compositions which can be used in accordance with the invention, better plant growth, increased tolerance to high or low temperatures, increased tolerance to drought or to salinity in the water or soil, increased flowering performance, facilitated harvesting, accelerated maturation, higher yields, higher quality and/or better nutritional value of the harvested products, better storage characteristics and/or processability of the harvested products are possible which exceed the effects which were actually to be expected.

The preferred transgenic plants or plant cultivars (those obtained by recombinant methods) to be treated in accordance with the invention include all those plants which, owing to the process of recombinant modification, were given genetic material which confers particular, advantageous, valuable traits to these plants. Examples of such properties are better plant growth, increased tolerance to high or low temperatures, increased tolerance to drought or to salinity in the water or soil, increased flowering performance, facilitated harvesting, accelerated maturation, higher yields, higher quality and/or higher nutritional value of the harvested products, better storage characteristics and/or better processability of the harvested products. Further examples of such traits, examples which must be mentioned especially, are better defense of the plants against animal and microbial pests, such as against insects, mites, phytopathogenic fingi, bacteria and/or viruses and an increased tolerance of the plants to certain herbicidal active compounds. Examples of transgenic plants which may be mentioned are the important crop plants, such as cereals (wheat, rice), maize, soybeans, potato, cotton, tobacco, oilseed rape and fruit plants (with the fruits apples, pears, citrus fruits and grapes), with particular emphasis on maize, soybeans, potatoes, cotton tobacco, and oilseed rape. Traits which are especially emphasized are the increased defense of the plants against insects, arachnids, nematodes, and slugs and snails owing to toxins being formed in the plants, in particular toxins which are generated in the plants by the genetic material of Bacillus thuringiensis (for example by the genes CryIA(a), CryIA(b), CryIA(c), CryIIA, CryIIIA, CryIIIB2, Cry9c Cry2Ab, Cry3Bb and CryIF and their combinations; hereinbelow “Bt plants”). Other traits which are particularly emphasized are the increased defense of plants against fungi, bacteria and viruses by the systemic acquired resistance (SAR), systemin, phytoalexins, elicitors and resistance genes and correspondingly expressed proteins and toxins. Other traits which are especially emphasized are the increased tolerance of the plants to certain herbicidal active compounds, for example imidazolinones, sulphonylureas, glyphosate or phosphinotricin (for example “PAT” gene). The genes which: confer the desired traits in each case may also be present in the transgenic plants in combination with one another. Examples of “Bt plants” which may be mentioned are maize cultivars, cotton cultivars, soybean cultivars and potato cultivars which are commercially available under the trade names YIELD GARD® (for example maize, cotton, soybeans), KnockOut® (for example maize), StarLink® (for example maize), Bollgard® (cotton), Nucotn® (cotton) and NewLeaf® (potato). Examples of herbicide-tolerant plants which may be mentioned are maize cultivars, cotton cultivars and soybean cultivars which are commercially available under the trade names Roundup Ready® (tolerance to glyphosate, for example maize, cotton, soybean), Liberty Link-® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include also the varieties commercially available under the name Clearfield® (for example maize). Naturally, these statements also apply to plant cultivars having these genetic traits or genetic traits still to be developed, which plant cultivars will be developed and/or marketed in the future.

The plants listed can be treated particularly advantageously according to the invention with the compounds of the general formula I or the active compound mixtures according to the invention. The preferred ranges stated above for the active compounds and mixtures also apply to the treatment of these plants. Particular emphasis may be given to the treatment of plants with the compounds or mixtures specifically mentioned in the present text.

The active compounds according to the invention are not only active against plant, hygiene and stored-product pests, but also, in the veterinary medicine sector, against animal parasites (ectoparasites), such as ixodid ticks, argasid ticks, scab mites, trombi-culid mites, flies (stinging and sucking), parasitic fly larvae, lice, hair lice, bird lice and fleas. These parasites include:

From the order of the Anoplurida, for example, Haematopinus spp., Linognathus spp., Pediculus spp., Phtirus spp., Solenopotes spp.

From the order of the Mallophagida and the sub-orders Amblycerina and Ischnocerina, for example, Trimenopon spp., Menopon spp., Trinoton spp., Bovicola spp., Werneckiella spp., Lepikentron spp., Damalina spp., Trichodectes spp., Felicola spp.

From the order of the Diptera and the sub-orders Nematocerina and Brachycerina, for example, Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp. and Melophagus spp.

From the order of the Siphonapterida, for example, Pulex spp., Ctenocephalides spp., Xenopyslla spp. and Ceratophyllus spp.

From the order of the Heteropterida, for example, Cimex spp., Triatoma spp., Rhodnius spp. and Panstrongylus spp.

From the order of the Blattarida, for example, Blatta orientalis, Periplaneta americana, Blattela germanica and Supella spp.

From the sub-class of the Acaria (Acarida) and the orders of the Meta- and Mesostigmata, for example, Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Stemostoma spp. and Varroa spp.

From the order of the Actinedida (Prostigmata) and Acaridida (Astigmata), for example, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp. and Laminosioptes spp.

The active compounds of the formula (I) according to the invention are also suitable for controlling arthropods which attack agricultural livestock, such as, for example, cattle, sheep, goats, horses, pigs, donkeys, camels, buffaloes, rabbits, chickens, turkeys, ducks, geese, honeybees, other domestic animals, such as, for example, dogs, cats, cage birds, aquarium fish, and so-called experimental animals, such as, for example, hamsters, guinea-pigs, rats and mice. By combating these arthropods, it is intended to reduce deaths and decreased performances (in meat, milk, wool, hides, eggs, honey and the like), so that more economical and simpler animal keeping is made possible by using the active compounds according to the invention.

In the veterinary sector, the active compounds according to the invention are used in a known manner by enteral administration, for example in the form of tablets, capsules, drinks, drenches, granules, pastes, boli, the feed-through method, suppositories, by parenteral administration, such as, for example, by means of injections (intramuscular, subcutaneous, intravenous, intraperitoneal and the like), implants, by nasal application, by dermal administration, for example in the form of dipping or bathing, spraying, pouring-on and spotting-on, washing, dusting, and with the aid of shaped articles which comprise active compound, such as collars, eat tags, tail marks, limb bands, halters, marking devices and the like.

When administered to livestock, poultry, domestic animals and the like, the active compounds of the formula (I) can be used as formulations (for example powders, emulsions, flowables) which comprise the active compounds in an amount of 1 to 80% by weight, either directly or after dilution by a factor of 100 to 10 000, or they may be used in the form of a chemical bath.

Furthermore, it has been found that the compounds according to the invention have a potent insecticidal action against insects which destroy industrial materials.

The following insects may be mentioned by way of example and as being preferred, but without any limitation:

Beetles, such, as Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec., Tryptodendron spec., Apate monachus, Bostrychus capucins, Heterobostrychus brunneus, Sinoxylon spec., Dinoderus minutus;

### Dermapterans, such as Sirex juvencus, Urocerus gigas, Urocerus gigas taignus, Urocerus augur;

### Termites, such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopssis nevadensis, Coptotermes formosanus;

### Bristletails, such as Lepisma saccharina.

Industrial materials are to be understood as meaning, in the present context, non-live materials, such as, preferably, synthetic, materials, glues, sizes, paper and board, leather, wood and timber products, and paint.

The materials to be very particularly preferably protected against attack by insects are wood and timber products.

Wood and timber products which can be protected by the composition according to the invention or mixtures comprising such a composition are to be understood as meaning, for example:

construction timber, wooden beams, railway sleepers, bridge components, jetties, wooden vehicles, boxes, pallets, containers, telephone poles, wood cladding, windows and doors made of wood, plywood, particle board, joiner's articles, or wood products which, quite generally, are used in the construction of houses or in joinery.

The active compounds can be used as such, in the form of concentrates or generally customary formulations, such as powders, granules, solutions, suspensions, emulsions or pastes.

The formulations mentioned can be prepared in a manner known per se, for example by mixing the active compounds with at least one solvent or diluent, emulsifier, dispersant and/or binder or fixative, water repellent, if appropriate desiccants and UV stabilizers and, if appropriate, colorants and pigments and other processing auxiliaries.

The insecticidal compositions or concentrates used for the protection of wood and wooden materials comprise the active compound according to the invention in a concentration of 0.0001 to 95% by weight, in particular 0.001 to 60% by weight.

The amount of the compositions or concentrates employed depends on the species and the occurrence of the insects and on the medium. The optimum rate of application can be determined upon use in each case by a test series. However, in general, it suffices to employ 0.0001 to 20% by weight, preferably 0.001 to 10% by weight, of the active compound, based on the material to be protected.

The solvent and/or diluent used is an organochemical solvent or solvent mixture and/or an oily or oil-type organochemical solvent or solvent mixture of low volatility and/or a polar organochemical solvent or solvent mixture and/or water and, if appropriate, an emulsifier and/or wetting agent.

Organochemical solvents which are preferably employed are oily or oil-type solvents having an evaporation number of above 35 and a flash point of above 30° C., preferably above 45° C.

Substances which are used as such oily and oil-type solvents which have low volatility and are insoluble in water are suitable mineral oils or their aromatic fractions, or mineral-oil-containing solvent mixtures, preferably white spirit, petroleum and/or alkylbenzene.

Substances which are advantageously used are mineral oils with a boiling range of 170 to 220° C., white spirit with a boiling range of 170 to 220° C., spindle oil with a boiling range of 250 to 350° C., petroleum or aromatics of boiling range 160 to 280° C., essence of turpentine and the like.

In a preferred embodiment, liquid aliphatic hydrocarbons with a boiling range of 180 to 210° C. or high-boiling mixtures of aromatic and aliphatic hydrocarbons with a boiling range of 180 to 220° C. and/or spindle oil and/or monochloronaphthalene, preferably α-monochloronaphthalene, are used.

The organic oily or oil-type, solvents of low volatility having an evaporation number of above 35 and a flash point of above 30° C., preferably above 45° C., can be partially replaced by organochemical solvents of high or medium volatility, with the proviso that the solvent mixture also has an evaporation number of above 35 and a flash point of above 30° C., preferably above, 45° C., and that the insecticide/fungicide mixture is soluble or emulsifiable in this solvent mixture.

In a preferred embodiment, part of the organochemical solvent or solvent mixture or an aliphatic polar organochemical solvent or solvent mixture is replaced. Substances which are preferably used are aliphatic organochemical solvents having hydroxyl and/or ester and/or ether groups, such as, for example, glycol ethers, esters and the like.

The organochemical binders used within the scope of the present invention are the synthetic resins and/or binding drying oils which are known per se and can be diluted with water and/or are soluble or dispersible or emulsifiable in the organochemical solvents employed, in particular binders composed of, or comprising, an acrylate resin, a vinyl resin, for example polyvinyl acetate, polyester resin, polycondensation or polyaddition resin, polyurethane resin, alkyd resin or modified alkyd resin, phenol resin, hydrocarbon resin, such as indene/cumarone resin, silicone resin, drying vegetable and/or drying oils and/or physically drying binders based on a natural and/or synthetic resin.

The synthetic resin used as the binder can be employed in the form of an emulsion, dispersion or solution. Up to 10% by weight of bitumen or bituminous substances can also be used as binders. In addition, colorants, pigments, water repellents, odor-masking substances and inhibitors or anticorrosives known per se and the like can also be employed.

The composition or the concentrate preferably comprises, in accordance with the invention, at least one alkyd resin or modified alkyd resin and/or a drying vegetable oil as the organochemical binder. Preferably used according to the invention are alkyd resins with an oil content of over 45% by weight, preferably 50 to 68% by weight.

All or some of the abovementioned binder can be replaced by a fixative (mixture) or a plasticizer (mixture). These additives are intended to prevent volatilization of the active compounds and crystallization or precipitation. They preferably replace 0.01 to 30% of the binder (based on 100% of binder employed).

The plasticizers are from the chemical classes of the phthalic esters, such as dibutyl phthalate, dioctyl phthalate or benzyl butyl phthalate, the phosphoric esters, such as tributyl phosphate, the adipic esters, such as di-(2-ethylhexyl) adipate, the stearates, such as butyl stearate or amyl stearate, the oleates, such as butyl oleate, the glycerol ethers or relatively high-molecular-weight glycol ethers, glycerol esters and p-toluenesulphonic esters.

Fixatives are chemically based on polyvinyl alkyl ethers, such as, for example, polyvinyl methyl ether, or ketones, such as benzophenone or ethylenebenzophenone.

Particularly suitable as a solvent or diluent is also water, if appropriate as a mixture with cone or more of the abovementioned organochemical solvents or diluents, emulsifiers and dispersants.

Particularly effective protection of wood is achieved by large-scale industrial impregnation processes, for example vacuum, double-vacuum or pressure processes.

If appropriate, the ready-to-use compositions can additionally comprise other insecticides and, if appropriate, additionally one or more fungicides.

Suitable additional components which may be admixed are, preferably, the insecticides and fungicides mentioned in WO 94/29 268. The compounds mentioned in that document are expressly part of the present application.

Very particularly preferred components which may be admixed are insecticides, such as chlorpyriphos, phoxim, silafluofin, alphamethrin, cyfluthrin, cypermethrin, deltamethrin, permethrin, imidacloprid, NI-25, flufenoxuron, hexaflumuron, transfluthrin, thiacloprid, methoxyphenoxid, triflumuron, chlothianidin, spinosad, tefluthrin,

and fungicides, such as epoxyconazole, hexaconazole, azaconazole, propiconazole, tebuconazole, cyproconazole, metconazole, imazalil, dichlofluanid, tolylfluanid, 3-iodo-2-propynylbutyl carbamate, N-octyl-isothiazolin-3-one and 4,5-dichloro-N-octylisothiazolin-3-one.

The compounds according to the invention can at the same time be employed for protecting objects which come into contact with salt water or brackish water, in particular hulls, screens, nets, buildings, moorings and signaling systems, against fouling.

Fouling by sessile Oligochaeta, such as Serpulidae, and by shells and species from the Ledamorpha group (goose barnacles), such as various Lepas and Scalpellum species, or by species from the Balanomorpha group (acorn barnacles), such as Balanus or Pollicipes species, increases the frictional drag of ships and, as a consequence, leads to a marked increase in operation costs owing to higher energy consumption and additionally frequent residence in the dry dock.

Apart from fouling by algae, for example Ectocarpus sp. and Ceramium sp., fouling by sessile Entomostraka groups, which come under the generic term Cirripedia (cirriped crustaceans), is of particular importance.

Surprisingly, it has now been found that the compounds, according to the invention, alone or in combination with other active compounds, have an outstanding antifouling action.

Using the compounds according to the invention, alone or in combination with other active compounds, allows the use of heavy metals such as, for example, in bis(trialkyltin) sulphides, tri-n-butyltin laurate, tri-n-butyltin chloride, copper(I) oxide, triethyltin chloride, tri-n-butyl-(2-phenyl-4-chlorophenoxy)tin, tributyltin oxide, molybdenum disulphide, antimony oxide, polymeric butyl titanate, phenyl-(bispyridine)-bismuth chloride, tri-n-butyltin fluoride, manganese ethylene-bisthiocarbamate, zinc dimethyldithiocarbamate, zinc ethylenebisthiocarbamate, zinc salts and copper salts of 2-pyridinethiol 1-oxide, bisdimethyldithiocarbamoylzinc ethylene-bisthiocarbamate, zinc oxide, copper(I) ethylene-bisdithiocarbamate, copper thiocyanate, copper naphthenate and tributyltin halides to be dispensed with, or the concentration of these compounds to be substantially reduced.

If appropriate, the ready-to-use antifouling paints can additionally comprise other active compounds, preferably algicides, fungicides, herbicides, molluscicides, or other antifouling active compounds.

Preferably suitable components in combination with the antifouling compositions according to the invention are:

algicides such as 2-tert-butylamino-4-cyclopropylamino-6-methylthio-1,3,5-triazine, dichlorophen, diuron, endothal, fentin acetate isoproturon, methabenzthiazuron, oxyfluorfen, quinoclamine and terbutryn;
fungicides such as benzo[b]thiophenecarboxylic acid cyclohexylamide S,S-dioxide, dichlofluanid, fluorfolpet, 3-iodo-2-propynyl butylcarbamate, tolylfluanid and azoles such as azaconazole, cyproconazole, epoxyconazole, hexaconazole, metconazole, propiconazole and tebuconazole;
molluscicides such as fentin acetate, metaldehyde, methiocarb, niclosamid, thiodicarb and trimethacarb; Fe chelates,
or conventional antifouling active compounds such as 4,5-dichloro-2-octyl-4-isothiazolin-3-one, diiodomethylparatryl sulfone, 2-(N,N-dimethylthiocarbamoylthio)-5-nitrothiazyl, potassium, copper, sodium and zinc salts of 2-pyridinethiol 1-oxide, pyridine-triphenylborane, tetrabutyldistannoxane, 2,3,5,6-tetrachloro-4-(methylsulfonyl)-pyridine, 2,4,5,6-tetrachloroisophthalonitrile, tetramethylthiuram disulfide and 2,4,6-trichlorophenylmaleimide.

The antifouling compositions used comprise the active compound according to the invention of the compounds according to the invention in a concentration of 0.001 to 50% by weight, in particular 0.01 to 20% by weight.

Moreover, the antifouling compositions according to the invention comprise the customary components such as, for example, those described in Ungerer, Chem. Ind. 1985, 37, 730-732 and Williams, Antifouling Marine Coatings, Noyes, Park Ridge, 1973.

Besides the algicidal, fungicidal, molluscicidal active compounds and insecticidal active compounds according to the invention, antifouling paints comprise, in particular, binders.

Examples of recognized binders are polyvinyl chloride in a solvent system, chlorinated rubber in a solvent system, acrylic resins in a solvent system, in particular in an aqueous system, vinyl chloride/vinyl acetate copolymer systems in the form of aqueous dispersions or in the form of organic solvent systems, butadiene/styrene/acrylonitrile rubbers, drying oils such as linseed oil, resin esters or modified hardened resins in combination with tar or bitumens, asphalt and epoxy compounds, small amounts of chlorine rubber, chlorinated polypropylene and vinyl resins.

If appropriate, paints also comprise inorganic pigments, organic pigments or colorants which are preferably insoluble in salt water. Paints may furthermore comprise materials such as rosin to allow controlled release of the active compounds. Furthermore, the paints may comprise plasticizers, modifiers which affect the rheological properties and other conventional constituents. The compounds according to the invention or the abovementioned mixtures may also be incorporated into self-polishing antifouling systems.

The active compounds are also suitable for controlling animal pests, in particular insects, arachnids and mites, which are found in enclosed spaces such as, for example, dwellings, factory halls, offices, vehicle cabins and the like. They can be employed in domestic insecticide products for controlling these pests alone or in combination with other active compounds and auxiliaries. They are active against sensitive and resistant species and against all development stages. These pests include:

From the order of the Scorpionidea, for example, Buthus occitanus.

From the order of the Acarina, for example, Argas persicus, Argas reflexus, Bryobia ssp., Dermanyssus gallinae, Glyciphagus domesticus, Ornithodorus moubat, Rhipicephalus sanguineus; Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalis, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Phthirus pubis.

From the order of the Heteroptera, for example, Cimex hemipterus, Cimex lectularius, Rhodinus prolixus, Triatoma infestans.

They are used in the household insecticides sector alone or in combination with other suitable active compounds such as phosphoric esters, carbamates, pyrethroids, neonicotinoids, growth regulators or active compounds from other known classes of insecticides.

They are used in aerosols, unpressurized spray products, for example pump and atomizer sprays, automatic fogging systems, foggers, foams, gels, evaporator products with evaporator tablets made of cellulose or polymer, liquid evaporators, gel and membrane evaporators, propeller driven evaporators, unenergized, or passive, evaporation systems, moth papers, moth bags and moth gels, as granules or dusts, in baits for spreading or in bait stations.

### PREPARATION EXAMPLES

The compound listed as Example 1 in table 1 (above) may for example be prepared as follows:

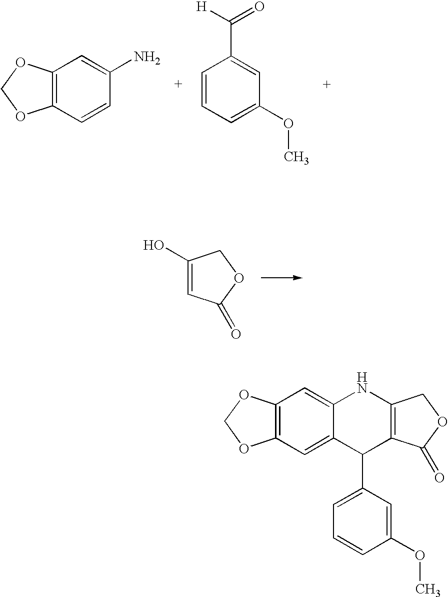

A mixture of 0.5 g (3.6 mmol) of 3,4-(methylenedioxy)aniline, 0.5 g (3.6 mmol) of 3-methoxybenzaldehyde, 0.36 g (3.6 mmol) of 4-hydroxy-5H-furan-2-one and 10 ml of ethanol is heated under reflux for 10 minutes. After cooling, the precipitate formed is isolated by filtration and washed with ethanol.

Yield: 1.13 g (92% of theory) of 6,7-(methylenedioxy)-9-(3-methoxyphenyl)-4,9-dihydro-3H-furo[3,4-b]quinolin-1-one.

¹H-NMR (DMSO-d₆, δ)=3.75 (s, 3H); 4.85 (d, 1H); 4.90 (s, 1H); 4.95 (d, 1H); 5.85 (s, 1H); 5.95 (s, 1H); 6.55 (s, 1H); 6.60 (s, 1H); 6.70-6.80 (m, 3H); 7.15 (t, 1H); 9.90 (s, 1H).

The compound listed as Example 107 in table 1 (above) may for example be prepared as follows:

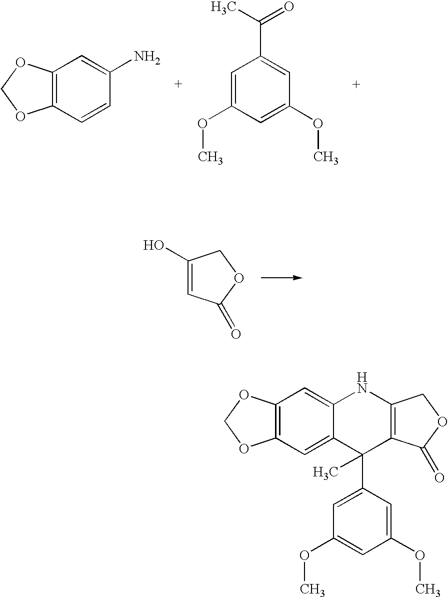

A mixture of 0.90 g (5 mmol) of 3,5-dimethoxyacetophenone, 50 mg (0.5 mmol) of 4-hydroxy-5H-furan-2-one and 10 ml of trifluoroacetic acid is heated under reflux for 3 hours. Following addition of 69 mg (0.5 mmol) of 3,4-(methylenedioxy)aniline the reaction mixture is heated under reflux for 3 hours more and then concentrated under reduced pressure. The residue is purified by column chromatography.

Yield: 55 mg (28% of theory) of 9-methyl-6,7-(methylenedioxy)-9-(3,4,5-trimethoxyphenyl)-4,9-dihydro-3H-furo[3,4-b]quinolin-1-one.

¹H-NMR (DMSO-d₆, δ)=1.87 (s, 3H); 3.70 (s, 6H); 4.82 (d, 1H); 4.90 (d, 1H); 5.91 (s, 1H); 5.93 (s, 1H); 6.32 (t, 1H); 6.41 (d, 2H); 6.47 (s, 1H); 6.60 (s, 1H); 9.87 (s, 1H).

The compound listed as Example 8 in table 1 (above) may for example be prepared as follows:

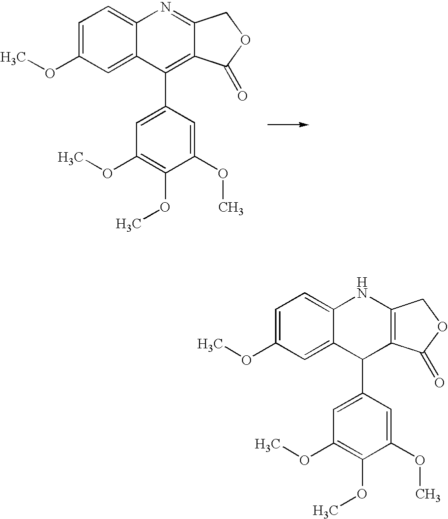

An initial charge of 250 mg (0.66 mmol) of 7-methoxy-9-(3,4,5-trimethoxyphenyl)-3H-furo[3,4-b]quinolin-1-one in 5 ml of glacial acetic acid is admixed at room temperature (approximately 20° C.) with 83 mg (1.32 mmol) of sodium cyanoborohydride. The reaction mixture is stirred at room temperature for 3 hours and then concentrated under reduced pressure. The residue is purified by column chromatography.

Yield: 240 mg (93% of theory) of 7-methoxy-9-(3,4,5-trimethoxyphenyl)-4,9-dihydro-3H-furo[3,4-b]quinolin-1-one.

¹H-NMR (DMSO-d₆, δ)=3.60 (s, 3H); 3.65 (s, 3H); 3.70 (s, 6H); 4.85 (d, 1H); 4.95 (s, 1H); 5.00 (d, 1H); 6.50 (s, 2H); 6.70 (d, 1H); 6.75 (dd, 1H); 6.85 (d, 1H); 9.90 (s, 1H).

The compound listed as Example 32 in table 1 (above) may for example be prepared as follows:

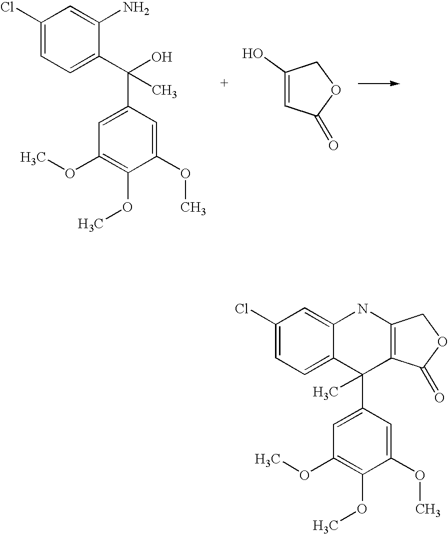

First 250 mg (0.74 mmol) of 1-(2-amino-4-chlorophenyl)-1-(3,4,5-trimethoxyphenyl)ethanol and 74 mg (0.74 mmol) of 4-hydroxy-5H-furan-2-one are heated at reflux together with 15.4 mg (0.07 mmol) of p-toluenesulfonic acid hydrate in 5 ml of toluene. After an hour the reaction mixture is cooled and concentrated under reduced pressure and the residue is purified by column chromatography.

Yield: 280 mg (94% of theory) of 6-chloro-9-methyl-9-(3,4,5-trimethoxyphenyl)-4,9-dihydro-3H-furo[3,4-b]quinolin-1-one.

¹H-NMR (DMSO-d₆, δ)==1.85 (s, 3H); 3.60 (s, 3H); 3.70 (s, 6H); 4.85 (d, 1H); 4.95 (d, 1H); 6.50 (s, 2H); 6.85 (s, 1H); 6.90 (d, 1H); 7.15 (d, 1H); 10.10 (s, 1H).

The compound listed as Example 25 in table 1 (above) may for example be prepared as follows:

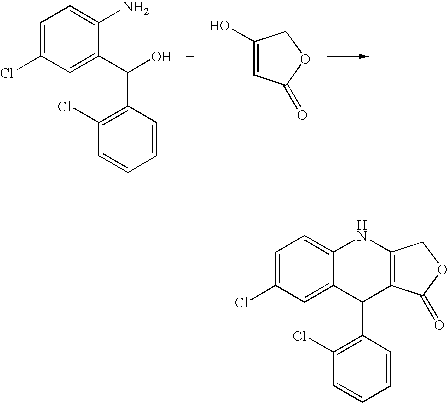

First 400 mg (1.49 mmol) of (2-amino-5-chlorophenyl)-(2-chlorophenyl)methanol and 149 mg (1.49 mmol) of 4-hydroxy-5H-furan-2-one are heated at reflux together with 31 mg (0.15 mmol) of p-toluenesulfonic acid hydrate in 5 ml of toluene. After 1 h the mixture is cooled and the precipitated solid is filtered off with suction, washed with methyl tert-butyl ether and dried under a high vacuum.

Yield: 250 mg (51% of theory) of 7-chloro-9-(2-chlorophenyl)-4,9-dihydro-3H-furo[3,4-b]quinolin-1-one.

¹H-NMR (DMSO-d₆, δ)=4.85 (d, 1H); 4.95 (d, 1H); 5.55 (s, 1H); 6.85 (d, 1H); 6.95 (d, 1H); 7.20 (d, 1H); 7.25-7.35 (m, 3H); 7.45 (d, 1H); 10.25 (s, 1H).

### EXAMPLES RELATING TO THE PREPARATION OF PRECURSORS

### Precursors of the Formula (VI)

### Stage 1

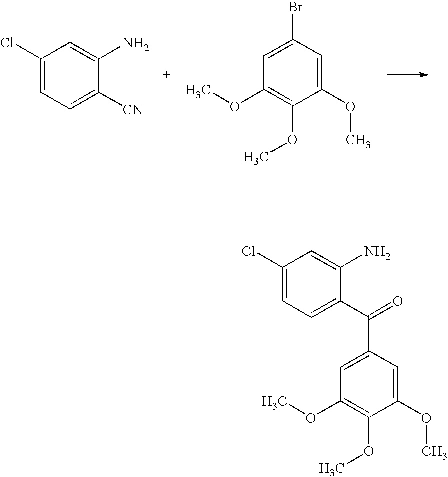

An initial charge of 0.64 g (26 mmol) of magnesium turnings in 30 ml of tetrahydrofuran is admixed with a few drops of 5-bromo-1,2,3-trimethoxybenzene and the mixture is heated at boiling until the solution becomes slightly turbid. Subsequently 6.5 g (26 mmol) of 5-bromo-1,2,3-trimethoxybenzene are added dropwise, during which the mixture is held at boiling. After the end of the addition it is heated under reflux for a further 2 hours. After the reaction mixture has cooled, 2.0 g (13.1 mmol) of 2-amino-4-chlorobenzonitrile, as a solution in 10 ml of tetrahydrofuran, are added dropwise and the mixture is heated under reflux for 1 hour. After the mixture has cooled to room temperature, 100 ml of 2 N hydrochloric acid are added cautiously dropwise, and the mixture is stirred at 30° C. for 2 hours. It is neutralized with 2 N aqueous sodium hydroxide solution and extracted repeatedly with methyl tert-butyl ether and the combined organic phase is washed with water, dried over sodium sulfate and concentrated under reduced pressure. The residue is purified by column chromatography.

Yield: 0.9 g (19% of theory) of (2-amino-4-chlorophenyl)-(3,4,5-trimethoxyphenyl)methanone.

¹H-NMR (DMSO-d₆, δ)=3.75 (s, 3H); 3.80 (s, 6H); 6.55 (dd, 1H); 6.80 (s, 2H); 6.90 (d, 1H); 7.20 (s, 2H); 7.35 (d, 1H).

### Stage 2

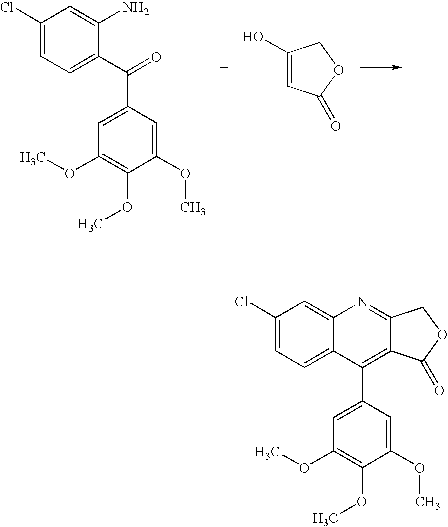

First 400 mg (1.13 mmol) of (2-amino-4-chlorophenyl)-(3,4,5-trimethoxyphenyl)methanone, 113 mg (1.13 mmol) of 4-hydroxy-5H-furan-2-one and 23 mg (0.11 mmol) of p-toluenesulfonic acid hydrate are heated at reflux in 10 ml of toluene. The mixture is left to cool and the precipitate formed is filtered off with suction and washed with toluene.

Yield: 400 mg (91% of theory) of 6-chloro-9-(3,4,5-trimethoxyphenyl)-3H-furo[3,4-b]quinolin-1-one.

¹H-NMR (DMSO-d₆, δ)=3.77 (s, 6H); 3.80 (s, 3H); 5.55 (s, 2H); 6.80 (s, 2H); 7.75 (dd, 1H); 7.95 (d, 1H); 8.25 (d, 1H).

### Precursors of the Formula (VII):

### Example VII-1

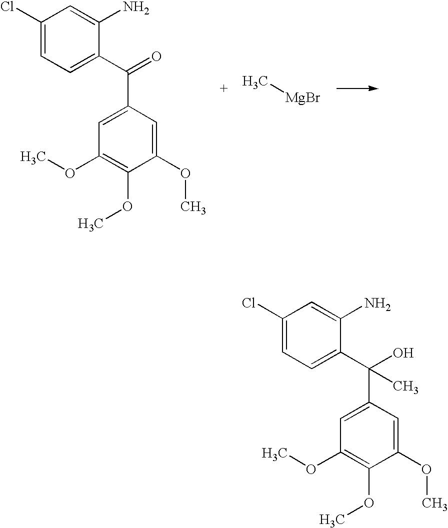

First 420 mg (1.3 mmol) of (2-amino-4-chlorophenyl)-(3,4,5-trimethoxyphenyl)methanone are suspended in 20 ml of diethyl ether and admixed dropwise with ice cooling with 1.3 ml of a 3 M solution of methyl magnesium bromide in diethyl ether (3.9 mmol). After the mixture has been stirred at room temperature for 5 hours, ice is added cautiously, and with ice cooling, and then the mixture is to a pH of 6 using 1 N hydrochloric acid. The organic phase is extracted by shaking with saturated aqueous sodium chloride solution, dried over sodium sulfate and concentrated under reduced pressure. The residue is purified by column chromatography.

Yield: 280 mg (60% of theory) of 1-(2-amino-4-chlorophenyl)-1-(3,4,5-trimethoxyphenyl)ethanol.

¹H-NMR (DMSO-d₆, δ)=1.75 (s, 3H); 3.60 (s, 3H); 3.70 (s, 6H); 5.30 (s, 2H); 5.95 (s, 1H); 6.50 (dd, 1H); 6.60 (m, 3H); 7.15 (d, 1H).

### Example VII-2

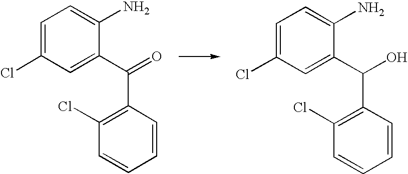

First 10 g (37.6 mmol) of (2-amino-5-chlorophenyl)-(2-chlorophenyl)methanone in 200 ml of methanol are admixed in portions with 1.42 g (37.6 mmol) of sodium borohydride and the mixture is then heated under reflux for 2 hours. After the reaction mixture has cooled, the residues of sodium borohydride are destroyed with dilute acetic acid and the entire solution is concentrated. The residue is taken up in dichloromethane, washed repeatedly with 5% strength aqueous sodium hydroxide solution and water, dried over magnesium sulfate and concentrated under reduced pressure. The residue is purified by column chromatography.

Yield: 9.18 g (91% of theory) of (2-amino-5-chlorophenyl)-(2-chlorophenyl)methanol.

¹H-NMR (DMSO-d₆, δ)=5.22 (s, 2H); 5.88 (d, 1H); 6.05 (d, 1H); 6.50 (d, 1H); 6.70 (d, 1H); 7.00 (dd, 1H); 7.30 (d, 1H); 7.35-7.45 (m, 2H); 7.65 (d, 1H).

### APPLICATION EXAMPLES

### Example A

### Phaedon Larvae Test (Spray Treatment)

### Solvents: 78 parts by weight of acetone 1.5 parts by weight of dimethylformamide

### Emulsifier: 0.5 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Disks of Chinese cabbage leaf (Brassica pekinensis) are sprayed with a preparation of active compound in the desired concentration and, after they have dried, are populated with larvae of the mustard beetle (Phaedon cochleariae).

After the desired time the activity in % is determined. 100% here means that all of the beetle larvae have been killed; 0% means that no beetle larvae have been killed.

In this test, for example, the following compounds of the preparation examples prove highly effective.

| Active | Active compound | Kill rate in |
|---|---|---|
| compounds | concentration in g/ha | % after 7^{d} |
| (61) | 500 | 100 |
| (70) | 500 | 100 |
| (69) | 500 | 100 |
| (3) | 500 | 100 |
| (8) | 500 | 100 |
| (12) | 500 | 100 |
| (18) | 500 | 100 |
| (20) | 500 | 83 |
| (35) | 500 | 100 |
| (45) | 500 | 100 |
| (114) | 500 | 83 |
| (113) | 500 | 100 |
| (56) | 500 | 100 |
| (73) | 500 | 83 |
| (75) | 500 | 100 |
| (76) | 500 | 100 |
| (77) | 500 | 100 |
| (86) | 500 | 100 |
| (90) | 500 | 100 |
| (93) | 500 | 100 |
| (99) | 500 | 83 |
| (100) | 100 | 83 |
| (103) | 500 | 100 |
| (126) | 500 | 100 |
| (128) | 500 | 100 |
| (130) | 500 | 100 |
| (133) | 500 | 100 |
| (136) | 500 | 83 |
| (139) | 500 | 83 |
| (142) | 500 | 100 |
| (145) | 500 | 83 |
| (155) | 500 | 100 |
| (157) | 500 | 100 |
| (161) | 500 | 100 |
| (174) | 500 | 100 |
| (179) | 500 | 100 |
| (184) | 500 | 100 |
| (185) | 500 | 100 |
| (191) | 500 | 100 |
| (200) | 500 | 100 |
| (203) | 500 | 100 |
| (204) | 500 | 100 |
| (184) | 500 | 100 |
| (185) | 500 | 100 |
| (191) | 500 | 100 |
| (200) | 500 | 100 |
| (203) | 500 | 100 |
| (204) | 500 | 100 |
| (205) | 500 | 100 |
| (207) | 500 | 100 |
| (210) | 500 | 100 |
| (212) | 500 | 100 |
| (217) | 500 | 100 |
| (218) | 500 | 100 |
| (221) | 500 | 100 |
| (223) | 500 | 100 |
| (225) | 500 | 100 |
| (249) | 500 | 100 |

### Example B

### Spodoptera frugiperda Test (Spray Treatment)

### Solvents: 78 parts by weight of acetone; 1.5 parts by weight of dimethylformamide

### Emulsifier: 0.5 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Disks of maize leaf (Zea mays) are sprayed with a preparation of active compound in the desired concentration and, after they have dried, are populated with larvae of the army worm (Spodoptera frugiperda).

After the desired time the activity in % is determined. 100% here means that all of the beetle larvae have been killed; 0% means that no beetle larvae have been killed.

In this test, for example, the following compounds of the preparation examples prove highly effective.

| Active | Active compound | Kill rate in % |
|---|---|---|
| compounds | concentration in g/ha | after 7^{d} |
| (1) | 500 | 100 |
| (6) | 500 | 100 |
| (9) | 500 | 100 |
| (19) | 500 | 100 |
| (17) | 500 | 100 |
| (16) | 500 | 100 |
| (23) | 500 | 100 |
| (35) | 500 | 100 |
| (45) | 500 | 100 |
| (116) | 500 | 100 |
| (111) | 500 | 100 |
| (56) | 500 | 100 |
| (73) | 500 | 83 |
| (74) | 500 | 100 |
| (75) | 500 | 100 |
| (77) | 500 | 100 |
| (84) | 500 | 100 |
| (86) | 500 | 100 |
| (90) | 500 | 100 |
| (93) | 500 | 100 |
| (100) | 500 | 100 |
| (101) | 500 | 100 |
| (102) | 500 | 100 |
| (103) | 500 | 100 |
| (106) | 500 | 100 |
| (123) | 500 | 100 |
| (126) | 500 | 83 |
| (128) | 500 | 83 |
| (129) | 500 | 100 |
| (133) | 500 | 83 |
| (136) | 500 | 100 |
| (139) | 500 | 100 |
| (140) | 500 | 100 |
| (142) | 500 | 100 |
| (145) | 500 | 100 |
| (148) | 500 | 100 |
| (153) | 500 | 100 |
| (157) | 500 | 100 |
| (158) | 500 | 100 |
| (161) | 500 | 100 |
| (162) | 500 | 100 |
| (173) | 500 | 100 |
| (174) | 500 | 100 |
| (175) | 500 | 83 |
| (178) | 500 | 100 |
| (179) | 500 | 100 |
| (184) | 500 | 100 |
| (185) | 500 | 100 |
| (193) | 500 | 100 |
| (196) | 500 | 100 |
| (197) | 500 | 100 |
| (198) | 500 | 100 |
| (199) | 500 | 83 |
| (200) | 500 | 100 |
| (201) | 500 | 100 |
| (202) | 500 | 100 |
| (203) | 500 | 100 |
| (204) | 500 | 100 |
| (205) | 500 | 100 |
| (206) | 500 | 100 |
| (207) | 500 | 100 |
| (208) | 500 | 100 |
| (209) | 500 | 83 |
| (210) | 500 | 100 |
| (212) | 500 | 100 |
| (215) | 500 | 100 |
| (217) | 500 | 100 |
| (218) | 500 | 100 |
| (219) | 500 | 100 |
| (221) | 500 | 100 |
| (223) | 500 | 100 |
| (224) | 500 | 100 |
| (225) | 500 | 100 |

### Example C

### Plutella Test

### Solvent: 7 parts by weight of dimethylformamide

### Emulsifier: 1 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Cabbage leaves (Brassica oleracea) are treated by being dipped in the preparation of active compound in the desired concentration and, after they have dried, are populated with larvae of the cabbage moth (Plutella xylostella).

After the desired time the activity in % is determined. 100% here means that all of the caterpillars have been killed; 0% means that no moth larvae have been killed.

In this test, for example, the compounds of preparation examples 3, 6 and 9 exhibit the high efficacy indicated below.

| Active | Active compound | Kill rate in |
|---|---|---|
| compounds | concentration in PPM | % after 7^{d} |
| (3) | 100 | 100 |
| (6) | 100 | 100 |
| (9) | 100 | 90 |

### Example D

### Heliothis virescens Egg Test (Spray Treatment)

### Solvent: 78 parts by weight of acetone; 1.5 parts by weight of dimethylformamide

### Emulsifier 0.5 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Soybean leaves (Glycine max) are sprayed with a preparation of active compound in the desired concentration and, after they have dried, are populated with eggs of the cotton bollworm (Heliothis virescens).

After the desired time, when the larvae have hatched, the activity in % is determined. 100% here means that none of the larvae have hatched; 0% means that the hatching of the larvae corresponds to that in the untreated control.

In this test, for example, the following compounds of the preparation examples prove highly effective.

| Active | Active compound | Kill rate in % |
|---|---|---|
| compounds | concentration in g/ha | after 7^{d} |
| (6) | 500 | 98 |
| (12) | 500 | 100 |
| (16) | 500 | 97 |
| (18) | 500 | 98 |
| (20) | 500 | 96 |
| (23) | 500 | 98 |
| (31) | 500 | 83 |
| (36) | 500 | 80 |
| (45) | 500 | 98 |
| (113) | 500 | 95 |
| (56) | 500 | 80 |
| (107) | 500 | 90 |
| (123) | 500 | 95 |
| (129) | 500 | 100 |
| (133) | 500 | 95 |
| (149) | 500 | 85 |
| (150) | 500 | 100 |
| (161) | 500 | 100 |
| (162) | 500 | 100 |
| (187) | 500 | 95 |

### Example E

### Spodoptera exigua Test

### Solvent: 7 parts by weight of dimethylformamide

### Emulsifier: 1 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Cabbage leaves (Brassica oleracea) are treated by being dipped in the preparation of active compound in the desired concentration and, after they have dried, are populated with larvae of the army worm (Spodoptera exigua).

After the desired time the activity in % is determined. 100% here means that all of the larvae have been killed; 0% means that no larvae have been killed.

In this test, for example, the compound of preparation example 3 exhibits superior efficacy over the prior art.

| Active | Active compound | Kill rate in % |
|---|---|---|
| compounds | concentration in ppm | after 7^{d} |
| (3) | 100 | 100 |

### Example F

### Tetranychus Test (OP-Resistant/Spray Treatment)

### Solvent: 78 parts by weight of acetone; 1.5 parts by weight of dimethylformamide

### Emulsifier: 0.5 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Disks of bean leaves (Phaseolus vulgaris) which are infested by all stages of the greenhouse red spider mite (Tetranychus urticae) are sprayed with an active compound preparation in the desired concentration.

After the desired time the activity in % is determined. 100% here means that all of the mites have been killed; 0% means that no mites have been killed.

In this test, for example, the compound of example 30 exhibits high efficacy.

| Active | Active compound | Kill rate in % |
|---|---|---|
| compounds | concentration in g/ha | after 7^{d} |
| (30) | 500 | 70 |

### Example G

### Meloidogyne Test (Spray Treatment)

### Solvent: 80 parts by weight of acetone

An appropriate preparation of active compound is prepared by mixing 1 part by weight of active compound with the stated amount of solvent and diluting the concentrate with water to the desired concentration.

Containers are filled with sand, solution of active compound, Meloidogyne incognita egg/larvae suspension, and lettuce seeds. The lettuce seeds germinate and the plants develop. On the roots, galls are formed.

After the desired time, the nematicidal effect is determined in % from the formation of galls. 100% here means that no galls were found; 0% means that the number of galls on the treated plants corresponds to that in the untreated control.

In this test, for example, the compounds of the preparation examples that are listed below exhibit high efficacy.

| | | Kill |
|---|---|---|
| | Active | rate |
| | compound | in in % |
| | conc. in | after |
| Active compounds | g/ha | 14^{d} |
| 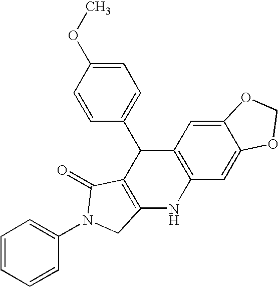 | 20 | 70 |
| 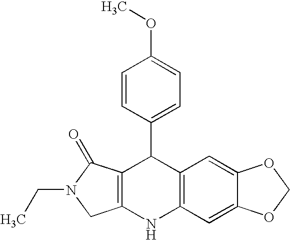 | 20 | 70 |
| (72) | 20 | 100 |
| (68) | 20 | 80 |

### Example H

### Myzus Test (Spray Treatment)

### Solvent: 78 parts by weight of acetone

1.5 parts by weight of dimethylformamide

### Emulsifier: 0.5 part by weight of alkylaryl polyglycol ether

An appropriate preparation of active compound is prepared by mixing 1 part by weight of active compound with the stated amounts of solvent and emulsifier and diluting the concentrate with emulsifier-containing water to the desired concentration.

Disks of Chinese cabbage leaf (Brassica pekinensis) which are infested by all stages of the green peach aphid (Myzus persicae) are sprayed with an active compound preparation in the desired concentration.

After the desired time the activity in % is determined. 100% here means that all of the aphids have been killed; 0% means that no aphids have been killed.

In this test, for example, the following compounds of the preparation examples exhibits high efficacy.

| Active | Active compound | Kill rate in % |
|---|---|---|
| compounds | concentration in g/ha | after 14^{d} |
| (211) | 500 | 80 |

What is claimed is:

1-7. (canceled)

8: A method of controlling animal pests comprising applying to the animal pests and/or their habitat and/or plants or parts of plants infested with pests a compound of formula (I) 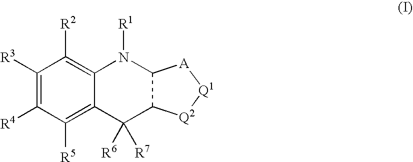
or a salt thereof,
in which
the bond depicted with dashes is a single bond or a double bond,
A is C═O, C═S, C═NR¹, or optionally substituted alkanediyl (alkylene),
Q¹ is a single bond or is O (oxygen), S (sulfur), NR¹, CO, CS, CNR¹, or optionally substituted alkanediyl,
Q² is O, S, SO, SO₂, C═O, C═S, C═NR¹, NR¹, CONR¹, or optionally substituted alkanediyl,
R¹ is H (hydrogen) or hydroxyl; or is optionally substituted alkyl, alkylcarbonyl, alkoxy, alkoxycarbonyl, alkylthio, alkylsulfinyl, alkylsulfonyl, alkenyl, alkenyloxy, alkynyl, alkynyloxy, cycloalkyl, cycloalkylcarbonyl, cycloalkylalkyl, aryl, arylcarbonyl, aryloxy, arylthio, arylsulfinyl, arylsulfonyl, arylalkyl, arylalkylcarbonyl, arylalkoxy, arylalkylthio, arylalkylsulfinyl, arylalkylsulfonyl, heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl, or heterocyclylalkylsulfonyl,
R² is H (hydrogen), hydroxyl, amino, nitro, cyano, carboxyl, carbamoyl, thiocarbamoyl, or halogen; or is optionally substituted alkyl, alkoxy, alkylthio, alkylsulfinyl, alkylsulfonyl, alkylamino, dialkylamino, dialkylaminocarbonyl or dialkylaminosulfonyl,
R³ is H, hydroxyl, amino, nitro, cyano, carboxyl, carbamoyl, thiocarbamoyl, or halogen; or is optionally substituted alkyl, alkoxy, alkylthio, alkylsulfinyl, alkylsulfonyl, alkylamino, dialkylamino, dialkylaminocarbonyl, or dialkylaminosulfonyl; or R³ together with R² is a benzo moiety, alkanediyl, oxaalkanediyl, or dioxaalkanediyl,
R⁴ is H, hydroxyl, amino, nitro, cyano, carboxyl, carbamoyl, thiocarbamoyl, or halogen; or is optionally substituted alkyl, alkoxy, alkylthio, alkylsulfinyl, alkylsulfonyl, alkylamino, dialkylamino, dialkylaminocarbonyl, or dialkylaminosulfonyl, or R⁴ together with R³ is a benzo moiety, alkanediyl, oxaalkanediyl, or dioxaalkanediyl,
R⁵ is H (hydrogen), hydroxyl, amino, nitro, cyano, carboxyl, carbamoyl, thiocarbamoyl, or halogen; or is optionally substituted alkyl, alkoxy, alkylthio, alkylsulfinyl, alkylsulfonyl, alkylamino, dialkylamino, dialkylaminocarbonyl, or dialkylaminosulfonyl; or R⁵ together with R⁴ is a benzo moiety, alkanediyl, oxaalkanediyl, or dioxaalkanediyl,
R⁶ is H or optionally substituted alkyl, and
R⁷ is H or is optionally substituted alkyl, cycloalkyl, cycloalkylalkyl, aryl, arylalkyl, heterocyclyl, or heterocyclylalkyl.

9: A method of controlling animal pests according to claim 8 comprising applying to the animal pests and/or their habitat and/or plants or parts of plants infested with pests a compound of formula (I) 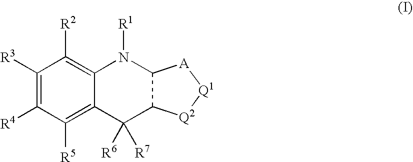
a salt thereof,
in which
the bond depicted with dashes is a single bond or a double bond,
A is C═O, C═S, or C═NR¹; or is C₁-C₆-alkanediyl that is optionally substituted by hydroxyl, cyano, halogen, C₁-C₄-alkoxy, or C₁-C₄-haloalkoxy and is optionally branched by being substituted by C₁-C₄-alkyl and/or spirocyclically linked with C₂-C₆-alkanediyl,
Q¹ is a single bond; is O (oxygen), S (sulfur), N—R¹, C═O, C═S, or C═NR¹; or is C₁-C₆-alkanediyl that is optionally substituted by hydroxyl, cyano, halogen, C₁-C₄-alkoxy, or C₁-C₄-haloalkoxy and is optionally branched by being substituted by C₁-C₄-alkyl and/or spirocyclically linked with C₂-C₆-alkanediyl,
Q² is O (oxygen), S (sulfur), SO, SO₂, CONR¹, C═O, C═S, or C═NR¹; or is C₁-C₆-alkanediyl that is optionally substituted by hydroxyl, cyano, halogen, C₁-C₄-alkoxy, or C₁-C₄-haloalkoxy and is optionally branched by being substituted by C₁-C₄-alkyl and/or spirocyclically linked with C₂-C₆-alkanediyl,
R¹ is H (hydrogen) or hydroxyl; is optionally hydroxyl-, cyano-, halogen-, C₁-C₄-alkoxy-, C₁-C₄-alkylthio-, C₁-C₄-alkylsulfinyl-, C₁-C₄-alkylsulfonyl-, C₁-C₄-alkylamino-, or di(C₁-C₄-alkyl)amino-substituted alkyl, alkylcarbonyl, alkoxy, alkoxycarbonyl, alkylthio, alkylsulfinyl, or alkylsulfonyl having in each case up to 6 carbon atoms in the alkyl groups; is optionally cyano- or halogen-substituted alkenyl, alkenyloxy, alkynyl, or alkynyloxy having in each case up to 6 carbon atoms; is optionally cyano-, halogen-, or C₁-C₄-alkyl-substituted cycloalkyl, cycloalkylcarbonyl, or cycloalkylalkyl having in each case up to 6 carbon atoms in the cycloalkyl group and optionally up to 4 carbon atoms in the alkyl moiety; is optionally nitro-, hydroxyl-, amino-, cyano-, carbamoyl-, thiocarbamoyl-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl-, C₁-C₄-haloalkylsulfonyl-, C₁-C₄-alkylamino-, di(C₁-C₄-alkyl)amino-, di(C₁-C₄-alkyl)aminocarbonyl-, di(C₁-C₄-alkyl)aminosulfonyl-, C₁-C₃-alkylenedioxy-, or C₁-C₃-haloalkylenedioxy-substituted aryl, arylcarbonyl, aryloxy, arylthio, arylsulfinyl, arylsulfonyl, arylalkyl, arylalkylcarbonyl, arylalkoxy, arylalkylthio, arylalkylsulfinyl, or arylalkylsulfonyl having in each case 6 or 10 carbon atoms in the aryl group and optionally up to 4 carbon atoms in the alkyl moiety; or is optionally nitro-, hydroxyl-, amino-, cyano-, carbamoyl-, thiocarbamoyl-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl-, C₁-C₄-haloalkylsulfonyl-, C₁-C₄-alkylamino-, di(C₁-C₄-alkyl)amino-, di(C₁-C₄-alkyl)aminocarbonyl-, di(C₁-C₄-alkyl)aminosulfonyl-, C₁-C₃-alkylenedioxy-, or C₁-C₃-haloalkylenedioxy-substituted heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl, or heterocyclylalkylsulfonyl, wherein the heterocyclyl moiety is saturated or unsaturated, monocyclic or bicyclic, and contains in each case up to 10 carbon atoms, 1 to 4 N atoms, and/or one O atom and/or one S atom,
R² is H (hydrogen), hydroxyl, amino, nitro, cyano, carboxyl, carbamoyl, thiocarbamoyl, or halogen; or is optionally hydroxyl-, cyano-, halogen-, C₁-C₄-alkoxy-, C₁-C₄-alkylamino-, or di(C₁-C₄-alkyl)amino-substituted alkyl, alkoxy, alkylthio, alkylsulfinyl, alkylsulfonyl, alkylamino, dialkylamino, dialkylaminocarbonyl, or dialkylaminosulfonyl having in each case up to 6 carbon atoms in the alkyl groups,
R³ is H (hydrogen), hydroxyl, amino, nitro, cyano, carboxyl, carbamoyl, thiocarbamoyl, or halogen; or is optionally hydroxyl-, cyano-, halogen-, C₁-C₄-alkoxy-, C₁-C₄-alkylamino-, or di(C₁-C₄-alkyl)amino-substituted alkyl, alkoxy, alkylthio, alkylsulfinyl, alkylsulfonyl, alkylamino, dialkylamino, dialkylaminocarbonyl, or dialkylaminosulfonyl having in each case up to 6 carbon atoms in the alkyl groups; or R³ together with R² is a benzo moiety or is alkanediyl, oxaalkanediyl, or dioxaalkanediyl having in each case up to 4 carbon atoms,
R⁴ is H (hydrogen), hydroxyl, amino, nitro, cyano, carboxyl, carbamoyl, thiocarbamoyl, or halogen; or is optionally hydroxyl-, cyano-, halogen-, C₁-C₄-alkoxy-, C₁-C₄-alkylamino-, or di(C₁-C₄-alkyl)amino-substituted alkyl, alkoxy, alkylthio, alkylsulfinyl, alkylsulfonyl, alkylamino, dialkylamino, dialkylaminocarbonyl, or dialkylaminosulfonyl having in each case up to 6 carbon atoms in the alkyl groups, or R⁴ together with R³ is a benzo moiety or is alkanediyl, oxaalkanediyl, or dioxaalkanediyl having in each case up to 4 carbon atoms,
R⁵ is H (hydrogen), hydroxyl, amino, nitro, cyano, carboxyl, carbamoyl, thiocarbamoyl, or halogen; or is optionally hydroxyl-, cyano-, halogen-, C₁-C₄-alkoxy-, C₁-C₄-alkylamino-, or di(C₁-C₄-alkyl)amino-substituted alkyl, alkoxy, alkylthio, alkylsulfinyl, alkylsulfonyl, alkylamino, dialkylamino, dialkylaminocarbonyl, or dialkylaminosulfonyl having in each case up to 6 carbon atoms in the alkyl groups; or R⁵ together with R⁴ is a benzo moiety or is alkanediyl, oxaalkanediyl, or dioxaalkanediyl having in each case up to 4 carbon atoms,
R⁶ is H (hydrogen) or is optionally hydroxyl-, cyano-, or halogen-substituted alkyl having up to 6 carbon atoms, and
R⁷ is H (hydrogen); is optionally hydroxyl-, cyano-, halogen-, C₁-C₄-alkoxy-, C₁-C₄-alkylthio-, C₁-C₄-alkylsulfinyl-, C₁-C₄-alkylsulfonyl-, C₁-C₄-alkylamino-, or di(C₁-C₄-alkyl)amino-substituted alkyl having up to 6 carbon atoms; is optionally cyano-, halogen-, or C₁-C₄-alkyl-substituted cycloalkyl or cycloalkylalkyl having in each case up to 6 carbon atoms in the cycloalkyl group and optionally up to 4 carbon atoms in the alkyl moiety; is optionally nitro-, hydroxyl-, amino-, cyano-, carbamoyl-, thiocarbamoyl-, phenyl-, phenoxy-, benzyloxy-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl-, C₁-C₄-haloalkylsulfonyl-, C₁-C₄-alkylamino-, di(C₁-C₄-alkyl)amino-, di(C₁-C₄-alkyl)aminocarbonyl-, di(C₁-C₄-alkyl)aminosulfonyl-, C₁-C₃-alkylenedioxy-, or C₁-C₃-haloalkylenedioxy-substituted aryl or arylalkyl having in each case 6 or 10 carbon atoms in the aryl group and optionally up to 4 carbon atoms in the alkyl moiety; or is optionally nitro-, hydroxyl-, amino-, cyano-, carbamoyl-, thiocarbamoyl-, halogen-, C₁-C₆-alkyl-, C₁-C₄-haloalkyl-, C₁-C₄-alkoxy-, C₁-C₄-haloalkoxy-, C₁-C₄-alkylthio-, C₁-C₄-haloalkylthio-, C₁-C₄-alkylsulfinyl-, C₁-C₄-haloalkylsulfinyl-, C₁-C₄-alkylsulfonyl-, C₁-C₄-haloalkylsulfonyl-, C₁-C₄-alkylamino-, di(C₁-C₄-alkyl)amino-, di(C₁-C₄-alkyl)aminocarbonyl-, di(C₁-C₄-alkyl)aminosulfonyl-, C₁-C₃-alkylenedioxy-, or C₁-C₃-haloalkylenedioxy-substituted heterocyclyl or heterocyclylalkyl, wherein the heterocyclyl moiety is saturated or unsaturated, monocyclic or bicyclic, and contains in each case up to 10 carbon atoms, 1 to 4 N atoms, and/or one O atom and/or one S atom.

10: A method of controlling animal pests according to claim 8 comprising applying to the animal pests and/or their habitat and/or plants or parts of plants infested with pests a compound of formula (I) 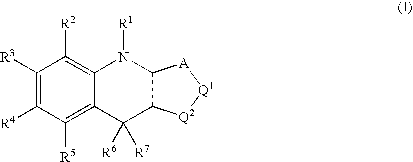
or a salt thereof,
in which
the bond depicted with dashes is a single bond or a double bond,
A is C═O, C═S, or C═NR¹; is optionally hydroxyl-, cyano-, fluoro-, chloro-, bromo-, methoxy-, ethoxy-, n- or isopropoxy-, monofluoromethoxy-, difluoromethoxy-, trifluoromethoxy-, monofluoroethoxy-, difluoroethoxy-, or trifluoroethoxy-substituted methylene, ethane-1,1-diyl, ethane-1,2-diyl (dimethylene), propane-1,1-diyl, propane-1,2-diyl, 2-methylpropane-1,2-diyl, propane-2,2-diyl, propane-1,3-diyl (trimethylene), or 4-methylpentane-2,2-diyl, or methylene that is spirocyclically linked to dimethylene, trimethylene, tetramethylene, or pentamethylene,
Q¹ is a single bond; is O (oxygen), S (sulfur), N—R¹, C═O, C═S, or C═NR¹; or is optionally hydroxyl-, cyano-, fluoro-, chloro-, bromo-, methoxy-, ethoxy-, n- or iso-propoxy-, monofluoromethoxy-, difluoromethoxy-, trifluoromethoxy-, monofluoroethoxy-, difluoroethoxy- or trifluoroethoxy-substituted methylene, ethane-1,1-diyl, ethane-1,2-diyl (dimethylene), propane-1,1-diyl, propane-1,2-diyl, 2-methylpropane-1,2-diyl, propane-2,2-diyl, propane-1,3-diyl (trimethylene), or 4-methylpentane-2,2-diyl, or methylene that is optionally spirocyclically linked with dimethylene, trimethylene, tetramethylene, or pentamethylene,
Q² is O (oxygen), S (sulfur), SO, SO₂, CONR¹, C═O, C═S, or C═NR¹; or is optionally hydroxyl-, cyano-, fluoro-, chloro-, bromo-, methoxy-, ethoxy-, n- or isopropoxy-, monofluoromethoxy-, difluoromethoxy-, trifluoromethoxy-, monofluoroethoxy-, difluoroethoxy- or trifluoroethoxy-substituted methylene, ethane-1,1-diyl, ethane-1,2-diyl (dimethylene), propane-1,1-diyl, propane-1,2-diyl, 2-methylpropane-1,2-diyl, propane-2,2-diyl, propane-1,3-diyl (trimethylene), or 4-methylpentane-2,2-diyl, or methylene that is spirocyclically linked with dimethylene, trimethylene, tetramethylene, or pentamethylene,
R¹ is H (hydrogen) or hydroxyl; is optionally hydroxyl-, cyano-, fluoro-, chloro-, bromo-, methoxy-, ethoxy-, n- or isopropoxy-, methylthio-, ethylthio-, n- or isopropylthio-, methylsulfinyl-, ethylsulfinyl-, methylsulfonyl-, ethylsulfonyl-, methylamino-, ethylamino-, n- or isopropylamino-, dimethylamino-, or diethylamino-substituted methyl, ethyl, n- or isopropyl, n-, iso-, s-, or t-butyl, acetyl, propionyl, n- or isobutyryl, methoxy, ethoxy, n- or isopropoxy, n-, iso-, s-, or t-butoxy, methoxycarbonyl, ethoxycarbonyl, n- or isopropoxycarbonyl, n-, iso-, s-, or t-butoxycarbonyl, methylthio, ethylthio, n- or isopropylthio, n-, iso-, s-, or t-butylthio, methylsulfinyl, ethylsulfinyl, n- or isopropylsulfinyl, methylsulfonyl, or ethylsulfonyl; is optionally cyano-, fluoro-, chloro-, or bromo-substituted ethenyl, propenyl, butenyl, pentenyl, propenyloxy, butenyloxy, pentenyloxy, ethynyl, propynyl, butynyl, pentynyl, propynyloxy, butynyloxy, or pentynyloxy; is optionally cyano-, fluoro-, chloro-, bromo-, methyl-, ethyl-, n- or isopropyl-substituted cyclopropyl, cyclobutyl, cyclopentyl, cyclohexyl, cyclopropylcarbonyl, cyclobutylcarbonyl, cyclopentylcarbonyl, cyclohexylcarbonyl, cyclopropyloxy, cyclobutyloxy, cyclopentyloxy, or cyclohexyloxy; is optionally nitro-, hydroxyl-, amino-, cyano-, carbamoyl-, thiocarbamoyl-, fluoro-, chloro-, bromo-, iodo-, methyl-, ethyl-, n- or isopropyl-, n-, iso-, s-, or t-butyl-, difluoromethyl-, trifluoromethyl-, dichloromethyl-, trichloromethyl-, chlorodifluoromethyl, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s-, or t-butoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s-, or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted phenyl, naphthyl, phenylcarbonyl (benzoyl), naphthylcarbonyl, phenoxy, naphthyloxy, phenylthio, naphthylthio, phenylsulfinyl, phenylsulfonyl, benzyl, phenylethyl, phenylpropyl, phenylacetyl, phenylpropionyl, phenylmethoxy, phenylethoxy, phenylpropoxy, phenylmethylthio, phenylethylthio, phenylmethylsulfinyl, or phenylmethylsulfonyl; or is optionally nitro-, hydroxyl-, amino-, cyano-, carbamoyl-, thiocarbamoyl-, fluoro-, chloro-, bromo-, iodo-, methyl-, ethyl-, n- or isopropyl-, n-, iso-, s-, or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s-, or t-butoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s-, or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl, or heterocyclylalkylsulfonyl, wherein the heterocyclyl moiety is selected from the series consisting of furyl, tetrahydrofuryl, thienyl, pyrrolyl, pyrrolinyl, pyrrolidinyl, pyrazolyl, pyrazolinyl, imidazolyl, imidazolinyl, oxazolyl, oxazolinyl, isoxazolyl, isoxazolinyl, thiazolyl, oxadiazolyl, thiadiazolyl, triazolyl, triazolinyl, pyridinyl, pyridazinyl, pyrimidinyl, and pyrazinyl,
R² is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, n-, iso, s-, or t-butyl, methoxy, ethoxy, n- or isopropoxy, n-, iso-, s-, or t-butoxy, methylthio, ethylthio, n- or isopropylthio, n-, iso-, s-, or t-butylthio, methylsulfinyl, ethylsulfinyl, n- or isopropylsulfinyl, methylsulfonyl, ethylsulfonyl, methylamino, ethylamino, n- or isopropylamino, n-, iso-, s-, or t-butylamino, dimethylamino, diethylamino, dimethylaminocarbonyl, diethylaminocarbonyl, dimethylaminosulfonyl, or diethylaminosulfonyl,
R³ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, n-, iso, s-, or t-butyl, methoxy, ethoxy, n- or isopropoxy, n-, iso-, s-, or t-butoxy, methylthio, ethylthio, n- or isopropylthio, n-, iso-, s-, or t-butylthio, methylsulfinyl, ethylsulfinyl, n- or isopropylsulfinyl, methylsulfonyl, ethylsulfonyl, methylamino, ethylamino, n- or isopropylamino, n-, iso-, s-, or t-butylamino, dimethylamino, diethylamino, dimethylaminocarbonyl, diethylaminocarbonyl, dimethylaminosulfonyl, or diethylaminosulfonyl; or R³ together with R³ is a benzo moiety or is optionally fluoro- and/or chloro- and/or methyl-substituted propane-1,3-diyl (trimethylene), butane-1,4-diyl (tetramethylene), 1-oxapropane-1,3-diyl, 1-oxabutane-1,4-diyl, 3-oxapentane-1,5-diyl, 1,3-dioxapropane-1,3-diyl (methylenedioxy), or 1,4-dioxabutane-1,4-diyl (dimethylenedioxy),
R⁴ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, n-, iso, s-, or t-butyl, methoxy, ethoxy, n- or isopropoxy, n-, iso-, s-, or t-butoxy, methylthio, ethylthio, n- or isopropylthio, n-, iso-, s-, or t-butylthio, methylsulfinyl, ethylsulfinyl, n- or isopropylsulfinyl, methylsulfonyl, ethylsulfonyl, methylamino, ethylamino, n- or isopropylamino, n-, iso-, s-, or t-butylamino, dimethylamino, diethylamino, dimethylaminocarbonyl, diethylaminocarbonyl, dimethylaminosulfonyl, or diethylaminosulfonyl; or R⁴ together with R³ is a benzo moiety or is optionally fluoro- and/or chloro- and/or methyl-substituted propane-1,3-diyl (trimethylene), butane-1,4-diyl (tetramethylene), 1-oxapropane-1,3-diyl, 1-oxabutane-1,4-diyl, 3-oxapentane-1,5-diyl, 1,3-dioxapropane-1,3-diyl (methylenedioxy), or 1,4-dioxabutane-1,4-diyl (dimethylenedioxy),
R⁵ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, n-, iso, s-, or t-butyl, methoxy, ethoxy, n- or isopropoxy, n-, iso-, s-, or t-butoxy, methylthio, ethylthio, n- or isopropylthio, n-, iso-, s-, or t-butylthio, methylsulfinyl, ethylsulfinyl, n- or isopropylsulfinyl, methylsulfonyl, ethylsulfonyl, methylamino, ethylamino, n- or isopropylamino, n-, iso-, s-, or t-butylamino, dimethylamino, diethylamino, dimethylaminocarbonyl, diethylaminocarbonyl, dimethylaminosulfonyl, or diethylaminosulfonyl; or R⁵ together with R⁴ is a benzo moiety or is optionally fluoro- and/or chloro- and/or methyl-substituted propane-1,3-diyl (trimethylene), butane-1,4-diyl (tetramethylene), 1-oxapropane-1,3-diyl, 1-oxabutane-1,4-diyl, 3-oxapentane-1,5-diyl, 1,3-dioxapropane-1,3-diyl (methylenedioxy), or 1,4-dioxabutane-1,4-diyl (dimethylenedioxy),
R⁶ is H (hydrogen) or is optionally hydroxyl-, cyano-, or halogen-substituted methyl, ethyl, n- or isopropyl, or n-, iso-, s-, or t-butyl, and
R⁷ is H (hydrogen); is optionally hydroxyl-, cyano-, fluoro-, chloro-, bromo-, methoxy-, ethoxy-, n- or isopropoxy-, methylthio-, ethylthio-, n- or isopropylthio-, methylsulfinyl-, ethylsulfinyl-, methylsulfonyl-, ethylsulfonyl-, methylamino-, ethylamino-, n- or isopropylamino-, dimethylamino-, or diethylamino-substituted methyl, ethyl, n- or isopropyl, n-, iso-, s-, or t-butyl; is optionally cyano-, fluoro-, chloro-, or methyl-substituted cyclopropyl, cyclopentyl, cyclohexyl, cyclopropylmethyl, cyclopentylmethyl, or cyclohexylmethyl; is optionally nitro-, hydroxyl-, amino-, cyano-, carbamoyl-, thiocarbamoyl-, phenyl-, phenoxy-, fluoro-, chloro-, bromo-, iodo-, methyl-, ethyl-, n- or isopropyl-, n-, iso-, s-, or t-butyl, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s-, or t-butoxy, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s-, or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted phenyl, naphthyl, benzyl, phenylethyl, or phenylpropyl; or is optionally nitro-, hydroxyl-, amino-, cyano-, carbamoyl-, thiocarbamoyl-, fluoro-, chloro-, bromo-, iodo-, methyl-, ethyl-, n- or isopropyl-, n-, iso-, s-, or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, n-, iso-, s-, or t-butoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, n-, iso-, s-, or t-butylthio-, difluoromethylthio-, trifluoromethylthio-, chlorodifluoromethylthio-, methylsulfinyl-, ethylsulfinyl-, n- or isopropylsulfinyl-, trifluoromethylsulfinyl-, methylsulfonyl-, ethylsulfonyl-, trifluoromethylsulfonyl-, methylamino-, ethylamino-, n- or isopropylamino-, dimethylamino-, diethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted heterocyclyl, heterocyclylcarbonyl, heterocyclyloxy, heterocyclylthio, heterocyclylsulfinyl, heterocyclylsulfonyl, heterocyclylalkyl, heterocyclylalkylcarbonyl, heterocyclylalkoxy, heterocyclylalkylthio, heterocyclylalkylsulfinyl, or heterocyclylalkylsulfonyl, wherein the heterocyclyl moiety is selected from the series consisting of furyl, tetrahydrofuryl, thienyl, pyrrolyl, pyrrolinyl, pyrrolidinyl, pyrazolyl, pyrazolinyl, imidazolyl, imidazolinyl, oxazolyl, oxazolinyl, isoxazolyl, isoxazolinyl, thiazolyl, oxadiazolyl, thiadiazolyl, triazolyl, triazolinyl, pyridinyl, pyridazinyl, pyrimidinyl, and pyrazinyl.

11: A method of controlling animal pests according to claim 8 comprising applying to the animal pests and/or their habitat and/or plants or parts of plants infested with pests a compound of formula (I) 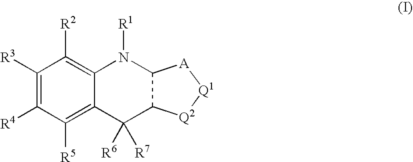
or a salt thereof,
in which
the bond depicted with dashes is a single bond or a double bond,
A is optionally hydroxyl-, fluoro-, chloro-, methoxy-, or ethoxy-substituted methylene, ethane-1,1-diyl, ethane-1,2-diyl (dimethylene), propane-1,1-diyl, propane-1,2-diyl, 2-methylpropane-1,2-diyl, or propane-2,2-diyl,
Q¹ is a single bond; is O (oxygen), or N—R¹; or is hydroxyl-, fluoro-, chloro-, methoxy-, or ethoxy-substituted methylene, ethane-1,1-diyl, ethane-1,2-diyl (dimethylene), propane-1,1-diyl, propane-1,2-diyl, 2-methylpropane-1,2-diyl, or propane-2,2-diyl,
Q² is O (oxygen), S (sulfur), SO, or SO₂; or is hydroxyl-, fluoro-, chloro-, methoxy-, or ethoxy-substituted methylene, ethane-1,1-diyl, ethane-1,2-diyl (dimethylene), propane-1,1-diyl, propane-1,2-diyl, 2-methylpropane-1,2-diyl, or propane-2,2-diyl with the proviso that Q¹ and Q² are different unless they are the same as A,
R¹ is H (hydrogen) or hydroxyl; is optionally hydroxyl-, cyano-, fluoro-, chloro-, methoxy-, ethoxy-, or n- or isopropoxy-substituted methyl, ethyl, n- or isopropyl, acetyl, propionyl, n- or isobutyryl, methoxy, ethoxy, n- or isopropoxy, methoxycarbonyl, ethoxycarbonyl, n- or isopropoxycarbonyl, methylthio, ethylthio, n- or isopropylthio, methylsulfinyl, ethylsulfinyl, methylsulfonyl, or ethylsulfonyl; is optionally fluoro-, chloro-, or bromo-substituted propenyl, butenyl, propenyloxy, butenyloxy, propynyl, or butynyl; is optionally fluoro-, chloro-, or methyl-substituted cyclopropyl, cyclopentyl, cyclohexyl, cyclopropylcarbonyl, cyclopentylcarbonyl, cyclohexylcarbonyl, cyclopropylmethyl, cyclopentylmethyl, or cyclohexylmethyl; is optionally nitro-, hydroxyl-, cyano-, carbamoyl-, thiocarbamoyl-, fluoro-, chloro-, bromo-, methyl-, ethyl-, n- or isopropyl-, n-, iso-, s-, or t-butyl, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted phenyl, phenylcarbonyl (benzoyl), phenoxy, phenylthio, phenylsulfinyl, phenylsulfonyl, benzyl, phenylethyl, phenylacetyl, phenylmethoxy, phenylethoxy, phenylmethylthio, phenylmethylsulfinyl, or phenylmethylsulfonyl,
R² is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl, or dimethylaminosulfonyl,
R³ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl, or dimethylaminosulfonyl; or R³ together with R² is a benzo moiety or methylenedioxy,
R⁴ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl, or dimethylaminosulfonyl; or R⁴ together with R³ is a benzo moiety or methylenedioxy,
R⁵ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, methylamino-, ethylamino-, n- or isopropylamino-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, methylamino, ethylamino, n- or isopropylamino, dimethylamino, dimethylaminocarbonyl, or dimethylaminosulfonyl; or R⁵ together with R⁴ is a benzo moiety or methylenedioxy,
R⁶ is H (hydrogen) or is optionally hydroxyl-, cyano-, fluoro-, or chloro-substituted methyl, ethyl, or n- or isopropyl, and
R⁷ is H (hydrogen); is optionally hydroxyl-, cyano-, fluoro-, chloro-, methoxy-, ethoxy-, or n- or isopropoxy-substituted methyl, ethyl, or n- or isopropyl; is optionally fluoro-, chloro-, or methyl-substituted cyclopropyl, cyclopentyl, cyclohexyl, cyclopropylmethyl, cyclopentylmethyl, or cyclohexylmethyl; is optionally nitro-, hydroxyl-, cyano-, carbamoyl-, thiocarbamoyl-, fluoro-, chloro-, bromo-, methyl-, ethyl-, n- or isopropyl-, n-, iso-, s-, or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted phenyl, benzyl, or phenylethyl; or is optionally fluoro-, chloro-, bromo-, methyl-, or ethyl-substituted thienyl or pyridinyl.

12: A method of controlling animal pests according to claim 8 comprising applying to the animal pests and/or their habitat and/or plants or parts of plants infested with pests a compound of formula (I) 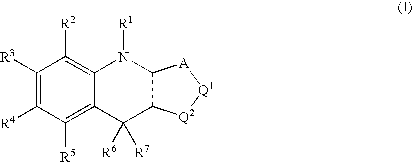
or a salt thereof,
in which
the bond depicted with dashes is a double bond,
A is methylene, ethane-1,1-diyl, ethane-1,2-diyl (dimethylene), propane-1,1-diyl, propane-1,2-diyl, or 2-methylpropane-1,2-diyl,
Q¹ is a single bond; is methylene, ethane-1,1-diyl, ethane-1,2-diyl (dimethylene), propane-1,1-diyl, propane-1,2-diyl or 2-methylpropane-1,2-diyl; or is O (oxygen) or N—R¹ in which R¹ is hydrogen, methyl, ethyl, n- or isopropyl, or phenyl,
Q² is methylene, is O (oxygen), S (sulfur), SO, SO₂, or CO, with the proviso that Q¹ and Q² are different unless they are both methylene,
R¹ is H (hydrogen); is optionally hydroxyl-, cyano-, fluoro-, chloro-, methoxy-, ethoxy-, or n- or isopropoxy-substituted methyl, ethyl, n- or isopropyl, acetyl, propionyl, n- or isobutyryl, methoxy, ethoxy, n- or isopropoxy, methoxycarbonyl, ethoxycarbonyl, n- or isopropoxycarbonyl, methylthio, ethylthio, n- or isopropylthio, methylsulfinyl, ethylsulfinyl, methylsulfonyl, or ethylsulfonyl; is optionally fluoro-, chloro-, or bromo-substituted propenyl, butenyl, propynyl, or butynyl; is optionally fluoro-, chloro-, or methyl-substituted cyclopropyl, cyclopentyl, cyclohexyl, cyclopropylcarbonyl, cyclopentylcarbonyl, cyclohexylcarbonyl, cyclopropylmethyl, cyclopentylmethyl, or cyclohexylmethyl; is optionally nitro-, hydroxyl-, cyano-, carbamoyl-, thiocarbamoyl-, fluoro-, chloro-, bromo-, methyl-, ethyl-, n- or isopropyl-, n-, iso-, s-, or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethyl-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy, trifluorodimethylenedioxy, or chlorodifluorodimethylenedioxy-substituted phenyl, phenylcarbonyl (benzoyl), phenylthio, phenylsulfinyl, phenylsulfonyl, benzyl, phenylethyl, phenylacetyl, phenylmethylthio, phenylmethylsulfinyl, or phenylmethylsulfonyl,
R² is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, dimethylamino, dimethylaminocarbonyl, or dimethylaminosulfonyl,
R³ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, dimethylamino, dimethylaminocarbonyl, or dimethylaminosulfonyl; or R³ together with R² is a benzo moiety,
R⁴ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, dimethylamino, dimethylaminocarbonyl, or dimethylaminosulfonyl; or R⁴ together with R³ is a benzo moiety,
R⁵ is H (hydrogen), hydroxyl, amino, nitro, cyano, carboxyl, carbamoyl, thiocarbamoyl, fluorine, chlorine, or bromine; or is optionally hydroxyl-, cyano-, fluoro-, chloro-, methoxy-, ethoxy-, n- or isopropoxy-, dimethylamino-, or diethylamino-substituted methyl, ethyl, n- or isopropyl, methoxy, ethoxy, n- or isopropoxy, methylthio, ethylthio, n- or isopropylthio, methylsulfinyl, ethylsulfinyl, methylsulfonyl, ethylsulfonyl, dimethylamino, dimethylaminocarbonyl, or dimethylaminosulfonyl; or R⁵ together with R⁴ is a benzo moiety,
R⁶ is H (hydrogen) or is optionally hydroxyl-, cyano-, fluoro-, or chloro-substituted methyl, ethyl, or n- or isopropyl, and
R⁷ is H (hydrogen); is optionally hydroxyl-, cyano-, fluoro-, chloro-, methoxy-, ethoxy-, or n- or isopropoxy-substituted methyl, ethyl, or n- or isopropyl; is optionally fluoro-, chloro-, or methyl-substituted cyclopropyl, cyclopentyl, cyclohexyl, cyclopropylmethyl, cyclopentylmethyl, or cyclohexylmethyl; is optionally nitro-, hydroxyl-, cyano-, carbamoyl-, thiocarbamoyl-, fluoro-, chloro-, bromo-, methyl-, ethyl-, n- or isopropyl-, n-, i-, s-, or t-butyl-, difluoromethyl-, trifluoromethyl-, dichloromethyl-, trichloromethyl-, chlorodifluoromethyl-, fluoroethyl-, difluoroethyl-, trifluoroethyl-, chloroethyl-, dichloroethyl-, trichloroethylene-, chlorofluoroethyl-, chlorodifluoroethyl-, methoxy-, ethoxy-, n- or isopropoxy-, difluoromethoxy-, trifluoromethoxy-, chlorodifluoromethoxy-, fluoroethoxy-, chloroethoxy-, difluoroethoxy-, dichloroethoxy-, chlorofluoroethoxy-, trichloroethoxy-, trifluoroethoxy-, chlorodifluoroethoxy-, methylthio-, ethylthio-, n- or isopropylthio-, difluoromethylthio-, trifluoromethylthio-, chlorodifluoromethylthio-, methylsulfinyl-, ethylsulfinyl-, trifluoromethylsulfinyl-, methylsulfonyl-, ethylsulfonyl-, trifluoromethylsulfonyl-, dimethylamino-, dimethylaminocarbonyl-, dimethylaminosulfonyl-, methylenedioxy-, dimethylenedioxy-, difluoromethylenedioxy-, difluorodimethylenedioxy-, trifluorodimethylenedioxy-, or chlorodifluorodimethylenedioxy-substituted phenyl, benzyl, or phenylethyl; or is optionally fluoro-, chloro-, bromo-, methyl-, or ethyl-substituted thienyl or pyridinyl.

13: A method of controlling animal pests according to claim 8 wherein the compound of formula (I) is in the form of a salt.

14: A method of producing a composition for controlling animal pests according to claim 8 comprising mixing a compound of formula (I) or a salt thereof with one or more solvents or diluents, emulsifiers, dispersants, and/or binder or fixative, water repellent, and optional desiccants and UV stabilizers and optional colorants and pigments and other processing auxiliaries.
